(19) United States
(12) Patent Application Publication
(10) Pub. No.: US 2010/0131856 A1
(43) Pub. Date: May 27, 2010

(54) Personalized, Online, Scientific Interface

(76) Inventors: Brian Joseph Kalbfleisch, Lombard, IL (US); Paul Joseph Chang, Chicago, IL (US); Steven Thomas Drew, Gurnee, IL (US); Christopher Daniel Carr, Glen Ellyn, IL (US); David Richard Pede, Lemont, IL (US); John William Basco, Westmont, IL (US); James Francis Basco, Downers Grove, IL (US)

Correspondence Address: VEDDER PRICE P.C., 222 N. LASALLE STREET, CHICAGO, IL, 60601, US

(21) Appl. No.: 12/324,246

(22) Filed: Nov. 26, 2008

(51) Int. Cl. G06F 3/048; G06F 15/16; G06F 21/22

(52) U.S. Cl. 715/741; 715/745; 715/760

(57) ABSTRACT

An Internet-based personalized, online, scientific interface is described, operating from at least a proprietary web server connected to the Internet for sending display images produced at the web server from any software application to a client web browser. The interface is personalized and includes, in addition to providing a gateway to different information databases, a search function, an archiving function, a specific bookmark function, an access to uploaded abstracts, and a personalized area. The interface includes a tool for upload, creation, venue presentation, and highly interactive web delivery presentation of a scientific paper or a poster by an author, linked with an internal tool for reviewing, accepting, and grading submitted abstracts for review. Within the personalized page, the interface includes a management tool for all abstracts uploaded to the interface, a follow-up tool and a system for managing the academic currency associated with the uploaded presentations including the capacity to produce feedback report associated with comments and viewing statistics. A digital presentation system allows attendees to comment on specific slides of presentations, have live or deferred communications with the presenter, rate the presentation, and even archive part or all of the presentation in the interface for later retrieval.

### FIELD OF THE DISCLOSURE

This disclosure relates to a personalized, online, scientific interface, an associated digital presentation system, and a method of management of the online scientific interface at a scientific venue, and more specifically, to an Internet-based interface for uploading scientific abstracts, creating and uploading an associated article or presentation, the management of this information within a personalized interface and at a scientific venue, and producing an associated feedback report, an academic currency report, or allowing a presenter a greater interface with users of the interface.

### BACKGROUND

It has now been the long-standing practice of the scientific community to promote science by giving researchers access to open forums. Doctoral candidates, professors, and practitioners in any scientific and even nonscientific fields are encouraged to read monthly publications of peer articles, attend conferences, and be familiar with regularly published books in their field. The Internet, a worldwide network of communication, is well adapted to facilitate the communication and exchange of information of these researchers, students, professors, and practitioners.

But with the new era of global communication, access to peers is better facilitated and the rate of transfer of information has increased to the point where useful and needed data is often accompanied by a sea of competing and potentially less useful information. The number of paper- and Internet-based publications has increased, the number of specialized websites and blogs offering information is increasing, and as a result, scientists often are unable to reach, archive, or retrieve the needed information again once it has been initially read. For example, radiologists, once presented with a handful of the most interesting cases in journals where each case was presented using a handful of small images on a static media such as paper, can now be given access to full scans comprising multiple images taken of the same patient at different angles, different locations, and different resolutions. When presented on a screen, digital images can be moved, focused, or presented at a greater resolution allowing for a better transfer of information. Where one radiologist may find one slide useful, a second radiologist may find another slide of greater interest to his or her practice. What is useful is an interface or a method of use thereof to improve the capacity to focus, access, and archive useful information from any location on the web while at the same time managing this information in a time- and cost-efficient manner.

Conferences are also organized at regular intervals, some on a yearly basis, such as, for example, the annual conference of the Radiological Society of North America. This conference promotes communication between the scientists in the field of radiology. Practitioners, researchers, doctors, and students are invited to travel to a chosen destination where a handful of the most relevant presentations and posters are presented in an open forum to promote discussion and dissemination of information. Currently, only a fraction of potential attendees are able to afford attending the conference in person, or attendees having interest in only a single presentation and do not think the benefits of partial attendance outweigh the time and financial burdens associated with attending the conference.

Also, only a handful of the abstracts submitted for presentation are ultimately chosen. Scientists of subspecialties, for example, may be forced to attend a three-day conference and are only given access to a handful of presentations in their subspecialties. What is needed is an interface or method that provides remote access to a greater number of presentations, namely, a system to manage, select, and promote the creation and uploading of abstracts from the scientific community. What is also needed is an interface or a method of granting greater access to the presentations to both attendees and remote-access viewers. For example, presenters also greatly benefit from interaction with attendees as they are able to monitor interest in their work.

Finally, most researchers shy away from using a single, personalized or proprietary interface for finding, accessing, and storing their know-how. Interfaces are often incomplete and offer little or no capacity to retrieve and store external sources of information. These interfaces are also very limited in their capacity to serve as a central site that is not dependant on the user for regular software updates. For example, radiologists desiring to view high-resolution images from a remote station must load a local software layer, configure their platform, and are often unable to store in a single database the result of external data collection. What is needed is an improved online interface capable of offering scientists a centralized service compatible with the above described needs.

### SUMMARY

This disclosure relates to an Internet-based, personalized, online, scientific interface operating from at least a proprietary web server connected to the Internet for sending display images produced at the web server from any software application to a client web browser. The transfer may be done using the HTTP protocol to transfer images as part of HTML code. The interface may be personalized to provide a gateway to different information databases, a search function, an archive function, a bookmark function, access to uploaded abstracts, or an area where data assembled and displayed based on personalized selection. The interface further includes a tool for upload, creation, presentation, and highly interactive web delivery presentation of a scientific paper or a poster by an author, which are linked with an internal tool for reviewing, accepting, and grading submitted abstracts for review. The interface also includes within the personalized page a management tool for all abstracts uploaded to the interface, a follow-up tool, and a system for managing the academic currency associated with the uploaded presentations, including the capacity to produce a feedback report associated with comments and viewing statistics.

Further, the interface includes an associated digital presentation system to allow attendees to comment on specific slides of presentations, have live or deferred communications with the presenter, and/or viewers of the presentation, rate the presentation, and even archive part or all of the presentation for later retrieval.

### BRIEF DESCRIPTION OF THE DRAWINGS

Certain preferred embodiments are shown in the drawings. However, it is understood that the present disclosure is not limited to the arrangements and instrumentality shown in the attached drawings.

FIG. 1 is a webpage illustrating a home page of an Internet-based website with access to a personalized, online, scientific interface according to an embodiment of the present disclosure.

FIG. 2 is a webpage illustrating the MyLogo tab of a personalized, online, scientific interface according to an embodiment of the present disclosure.

FIG. 3 is a webpage illustrating the MySearch tab of a personalized, online, scientific interface according to an embodiment of the present disclosure.

FIG. 4 is a webpage illustrating the MyBookmarks tab of a personalized, online, scientific interface according to an embodiment of the present disclosure.

FIG. 5 is a webpage illustrating the MyFiles tab of a personalized, online, scientific interface according to an embodiment of the present disclosure.

FIG. 6 is a diagram representation of the interrelations between the different elements connected to the Internet of the personalized, online, scientific interface according to an embodiment of the present disclosure.

FIG. 7A is an illustration of the pop-up window opened as a results of selecting an “add to my bookmarks” button on the personalized, online, scientific interface according to an embodiment of the present disclosure.

FIG. 7B is a diagrammatic representation of the scroll down menu for selection and storage of the bookmarked item according to the step shown in FIG. 7A.

FIG. 8 is a webpage illustration of the webpage displayed as a result of selecting the MySearch tab shown in FIG. 3 and further selecting the video tab on the personalized, online, scientific interface according to an embodiment of the present disclosure.

FIG. 9 is a webpage illustration of the digital presentation system according to an embodiment of the present disclosure.

FIG. 10 is an illustration of the Communities webpage displayed once the Communities tab is pressed on the webpage shown in FIG. 9 according to an embodiment of the present disclosure.

FIG. 11 is an illustration of the Scientific Sessions webpage displayed once the Scientific Session tab is pressed on the webpage shown in FIG. 9 according to an embodiment of the present disclosure.

FIG. 12 is an illustration of the Presentation webpage displayed once the Presentation tab is pressed on the webpage shown in FIG. 9 according to an embodiment of the present disclosure.

FIG. 13A is an illustration of the MySearch webpage displayed as a result of selecting the MySearch tab shown in FIG. 3 and further selecting the Image tab on the personalized, online, scientific interface according to an embodiment of the present disclosure.

FIG. 13B is an illustration of the pop-up window displayed as a result of a selection of the image to be displayed as shown in FIG. 13A according to an embodiment of the present disclosure.

FIG. 14 is an illustration of the webpage displayed as a result of selecting the MySearch tab shown in FIG. 3 and further selecting the Electronic Exhibit tab on the personalized, online, scientific interface according to an embodiment of the present disclosure.

FIG. 15 is a representation of the legends associated with the display of an image and a video as shown in FIGS. 8 and 13A according to an embodiment of the present disclosure.

FIG. 16 is a representation of the webpage displayed as a result of selecting the MySearch tab shown in FIG. 3 and further selecting the Bookmark Results tab on the personalized, online, scientific interface according to an embodiment of the present disclosure.

FIG. 17 is a representation of the webpage displayed as a result of selecting MyBookmarks on the personalized, online, scientific interface of FIG. 3 and selecting a bookmarked webpage according to an embodiment of the present disclosure.

FIG. 18 is a representation of the webpage displayed as a result of selecting MyBookmarks on the personalized, online, scientific interface of FIG. 3 and selecting a bookmarked image according to an embodiment of the present disclosure.

FIG. 19 is a representation of the webpage displayed as a result of selecting MyBookmarks on the personalized, online, scientific interface of FIG. 3 and selecting a text file according to an embodiment of the present disclosure.

FIG. 20 is a representation of the webpage displayed as a result of selecting MyBookmarks on the personalized, online, scientific interface of FIG. 3 and selecting a subdirectory with video presentations according to an embodiment of the present disclosure.

FIG. 21 is a representation of the webpage displayed as a result of selecting MyBookmarks on the personalized, online, scientific interface of FIG. 3 and selecting a subdirectory with images of screenshots according to an embodiment of the present disclosure.

FIG. 22 is a representation of the home webpage of a presentation editor for working on a presentation or uploading an abstract to the personalized, online, scientific interface according to an embodiment of the present disclosure.

FIG. 23 is a representation of the webpage displayed from the webpage shown as FIG. 22 and after selecting one of the listed presentations according to an embodiment of the present disclosure.

FIGS. 24 and 25 are webpages displayed to enter the type of presentation to be prepared and assigning a parent category and a subcategory for the presentation according to an embodiment of the present disclosure.

FIGS. 26 to 28 are sample pages of the data entry interface to enter information associated with a presentation as shown in FIG. 22 according to an embodiment of the present disclosure.

FIG. 29 is a webpage showing for a specific category and subcategory the different abstracts associated with their assigned grades according to an embodiment of the present disclosure.

FIG. 30 is a pop-up window from the webpage illustrated as FIG. 29 showing a breakdown of the grades given by the different graders of an abstract as shown in FIG. 22 according to an embodiment of the present disclosure.

FIG. 31 is a pop-up window with the abstract disclosure associated with a presentation shown in FIG. 22 according to an embodiment of the present disclosure.

FIG. 32 is a summary window of the grading completion of the different abstracts submitted through the online scientific interface according to an embodiment of the present disclosure.

FIG. 33 is a quick-grade window for a grader assigned a plurality of abstracts submitted through the personalized, online, scientific interface according to an embodiment of the present disclosure.

FIG. 34 is a summary table of the grading for different presentations submitted through the personalized, online, scientific interface according to another embodiment of the present disclosure.

FIG. 35 is a webpage presentation of the online editor for presentations submitted through the personalized, online, scientific interface according to an embodiment of the present disclosure.

FIG. 36 is a schematic representation of the Internet representation of the different elements of a system with the personalized, online, scientific interface according to an embodiment of the present disclosure.

FIG. 37 is a schematic representation of the method for managing a venue using a personalized, online, scientific interface according to an embodiment of the present disclosure.

### DETAILED DESCRIPTION

For the purposes of promoting and understanding the invention and principles disclosed herein, reference is now made to the preferred embodiments illustrated in the drawings, and specific language is used to describe the same. It is nevertheless understood that no limitation of the scope of the invention is thereby intended. Such alterations and further modifications in the illustrated devices and such further applications of the principles disclosed as illustrated herein are contemplated as would normally occur to one skilled in the art to which this disclosure relates.

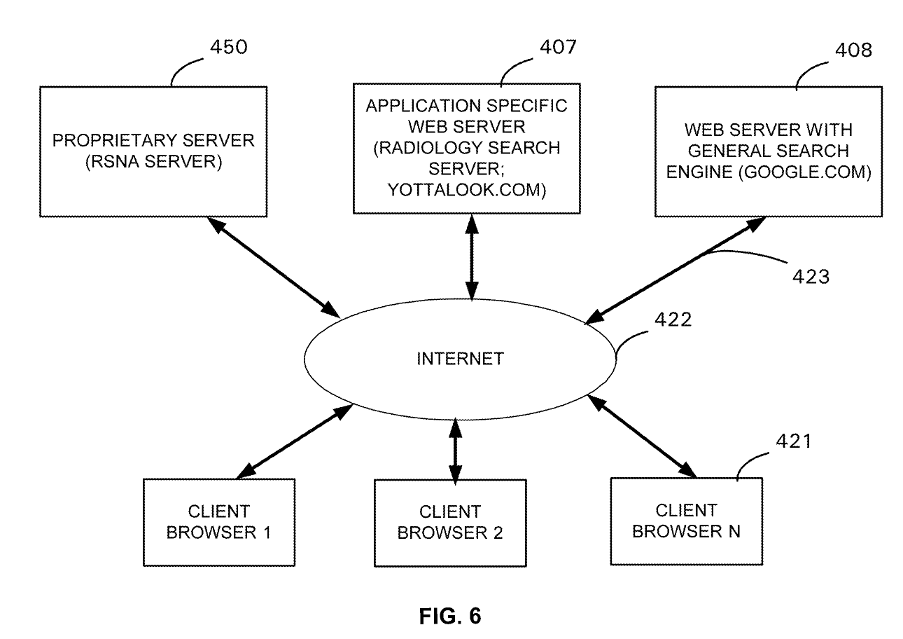

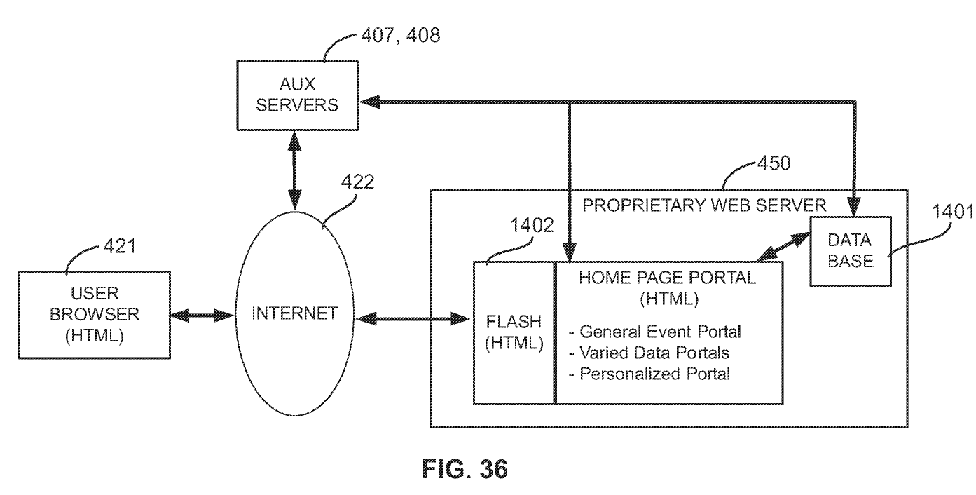

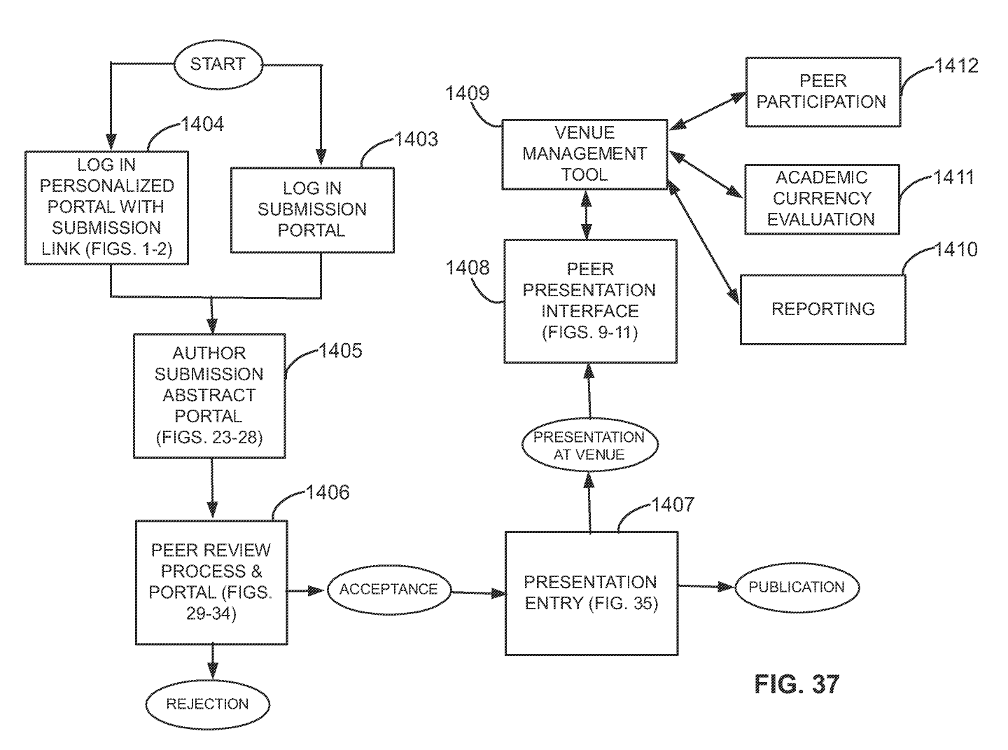

FIG. 36 shows a web server 450, such as a proprietary server connected to a database 1401 for storage of information, auxiliary servers such as application-specific web servers 407 such as, for example, a radiology search server like Yottalook.com, and a web server with general search engine 408 such as, for example, google.com. The proprietary server 450 is connected to the Internet 422 and to the different client browsers 421 as shown in FIG. 6. These browsers use an HTML reader capable of uploading a response from a request from a web server as is well known in the art. In one embodiment, the browser uploads HTML pages sent via the HTTP protocol. While one technology of browser and one type of associated data communication protocol is shown as the current, most-implemented protocol and browser interface, what is contemplated is any type of browsing technology using any type of communication protocol capable of resulting in the upload of information to the user display from a remote server linked as part of a global or local network of data communication.

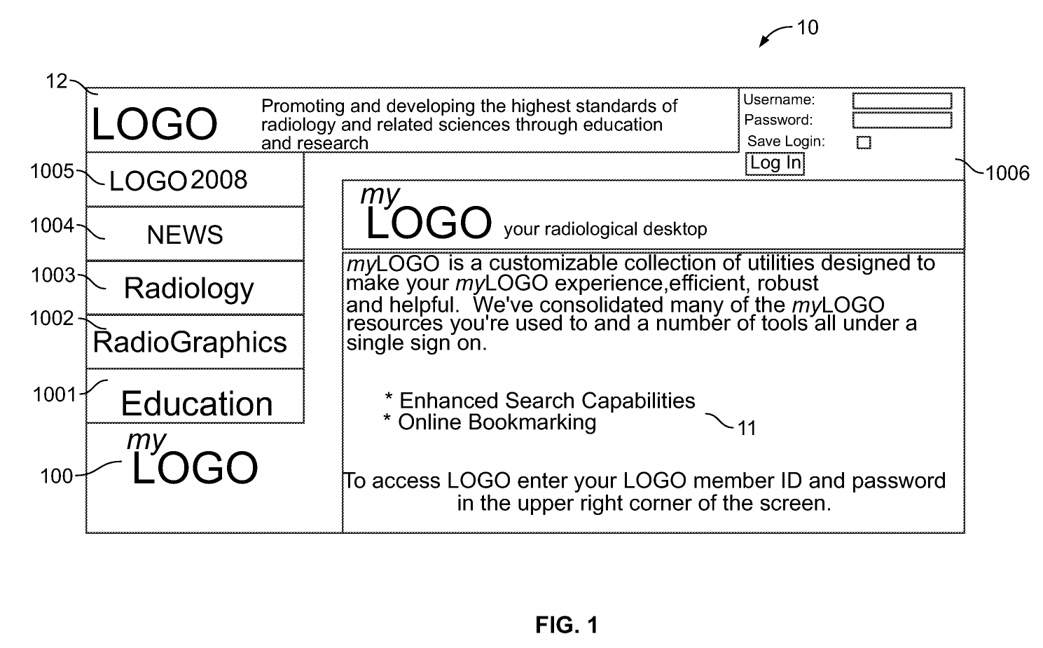

FIG. 36 also shows as 1402 how the home page portal creates data for a general event portal 1005, a varied data portal 1004/1003/1002/1001, or a personalized portal 100 shown in FIG. 1., and transforms these executables into HTML format using, for example, what is known as Flash technology. Flash technology can manipulate vector and raster graphics and supports bidirectional streaming of audio and video. Files in Flash typically use a .swf file extension, also known as ShockWave Flash, and may be adapted as an object embedded in a webpage or as part of a Flash executable. While one possible technology is shown to process different sources of information at the web server 450 for ultimate transfer in a uniform format to the web browser 421, other data transfer technologies are also contemplated.

While database 1401 in shown in FIG. 36 on the same platform as the web server 450, database 1401 can be located locally, remotely, or as part of any type of data storage that can be functionally connected with the home web server 450 for running the personalized, online, scientific interface 10.

Turning now to FIG. 1, the personalized, online, scientific interface 10 as shown includes a user access box 1006 having a username data entry field, a password data entry field, and a save login data entry field along with a button for sending the entered information. In this disclosure, all functions and data entry methods associated with the different interfaces are not described with particularity because they are well known to one of ordinary skill in the art. For example, while a user may use a mouse to click on the Login box, under most operating systems, hitting the Enter key on a keyboard results in the same action.

The personalized, online, scientific interface 10 also includes a presentation surface such as 12 where a logo can be displayed alongside information. While no external features such as online publicity are shown, the use of these features as part of the interface 10 is contemplated. On the left portion of FIG. 1, tabs can be clicked to gain access to a general event portal 1005, such as the annual RSNA conference at an external venue, a variety of data portals, such as a news button 1004 to access recent news items, a radiology tab 1003 to gain access to a first source of data either as publications, a database, or any other medium, and other tabs, such as educational data 1001 or graphical data 1002. A personalized, online, scientific interface 100 is accessed by selected a tab as shown in the area where myLOGO is found.

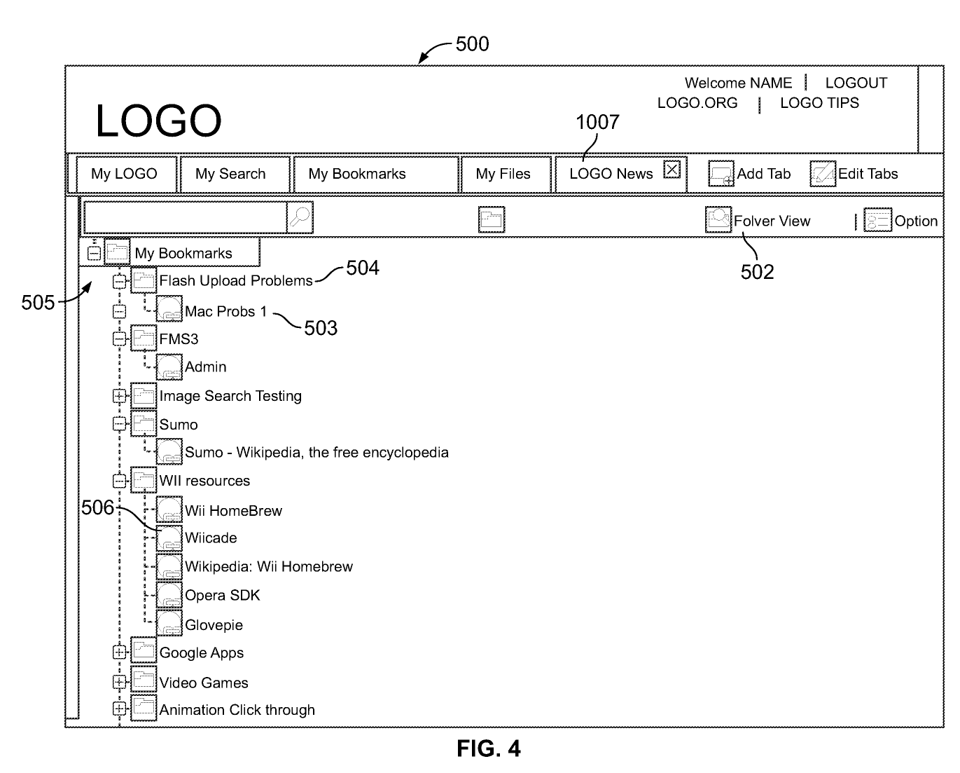

By selecting the myLOGO area 100, a webpage illustrating the MyLogo tab of a personalized, online, scientific interface is accessed. In this subsequent webpage, as for every webpage uploaded via a browser through the Internet or any other network connected to a server where the interface is run in memory, a series of tab is shown. A presentation surface 12 may include a series of tabs 110, 400, 500, and 600 or other elements for the selection of steps in the interface 111, such as, for example, an Add Stuff button to add new windows in the personalized tab 110. While a window with My Abstracts 170 is shown, it may be absent from the personalized tab either because it was never selected by a user or because it was removed from the personalized area in the page. By selecting the Add Stuff button, a pop-up box appears and the user is invited to scroll down and select any new window to add to the personalized tab 110. Another button on the interface 111 is the Add Tab button that allows for additional tabs to be included alongside the tabs shown 110, 400, 500, and 600. Several tabs are shown on the personalized tab 110, namely, the Search tab 400, the Bookmark tab 500, and the My Files tab 600. FIG. 4 shows an example where a NEWS tab 1007 has been added.

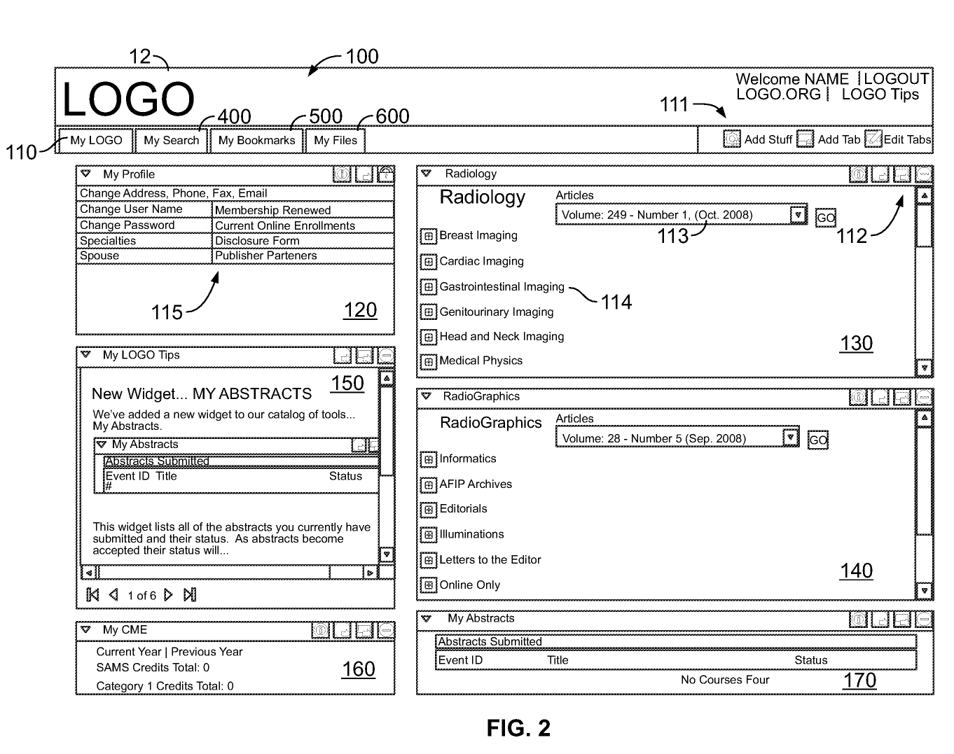

Returning to FIG. 2, in the personalized area of the personalized tab 110, several possible windows are shown, such as a user profile box 120, a first window to a reference database 130, a second window to another reference database 140, a tips window 150, and a box with updated user information from a database 160, such as a legal education requirement. In the user profile window 120, a series of personal information 115 can be entered, such as contact information, user name, passwords, membership information to the interface, or any other type of information that is used in a profile. Each of the windows as shown includes small, functional buttons 112 to add functions and navigate within the associated window, pull-down menus 113, lists of elements often associated with an HTML link 114, or text information. While a handful of possible tools for operating within an online environment are displayed, what is contemplated is the use of any type of tool associated with any known or programmable feature or interface.

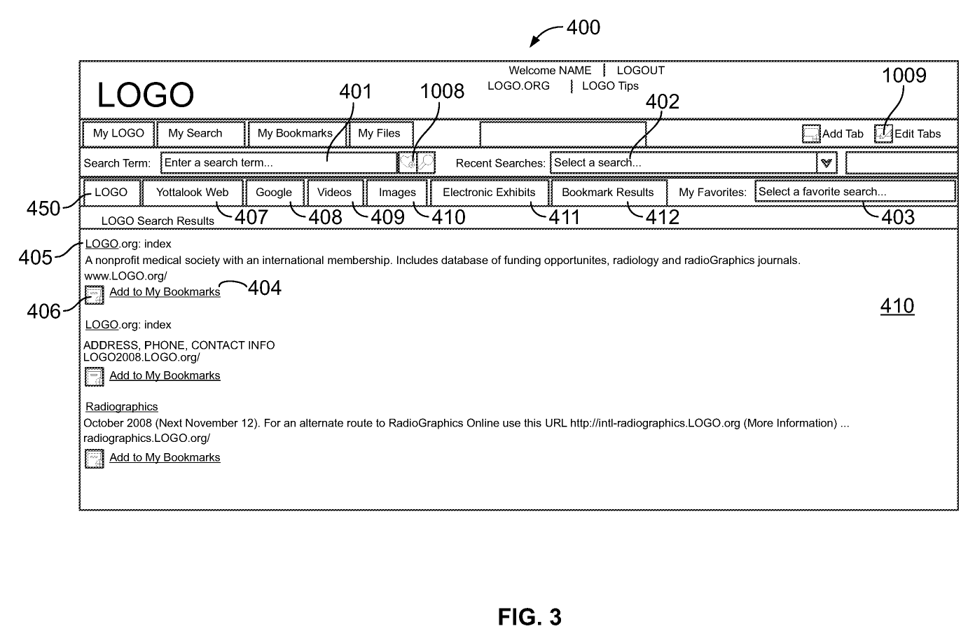

FIG. 3 is a webpage illustrating the MySearch tab 400 of a personalized, online, scientific interface 100 according to an embodiment of the present disclosure. The MySearch tab 400 is a personalized search tab where, through a series of tools such as drop bars, icons, and tabs, different types of searches can be accessed and run. For example, a search term can be entered in a bar 401, and icons 1008 next to the bar can stored the recent searches, favorite searches, or launch the search query. Another bar 402 allows for a search of recent searches. For example, the interface can be programmed to store or recall the last searches for subsequent searches using the same terms. The use of History buttons as used in web browsers is also contemplated along with any type of stored histogram.

As shown in FIG. 3, a series of horizontal tabs are associated with different families of searches, the first 450 is associated with searches at the proprietary server or at the server of a certain service provider, and the second tab 407 is directed to a specific web server, such as, for example, the website Yottalook Web, a search engine in the medical field. Next, a general search web server tab 408 such as Google.com is provided. A search is run if this tab is activated, which searches the content of this web platform and return hits in the window area 410 associated with the search engine. The same can be said for all tabs. Buttons on the upper right corner of the MySearch page 400 also provide tools for adding and editing tabs 1009. Other tabs 408, 409, 410, 411, and 412 allow for searching in other subareas of data that can be found either locally on the proprietary server or on a remote server. For example, tab 412 allows for the search in the bookmarked results.

When a bookmark of any piece of data is selected and added as a bookmark in the personalized bookmark, the interface 100 stores or uploads the data associated with the bookmark either on a server, either proprietary or remote, or creates an object link to the remote piece of information for later retrieval. In one contemplated embodiment, the data is uploaded on the proprietary server for easier access and retrieval from any remote user browser through the Internet. While one method of storage of the information to be searched is shown, what is contemplated is the use of any parser or object technology needed to associate the bookmark with the underlying bookmarked data.

Window area 410 shows a conventional and well-known list of hits returned from the search engine arranged sequentially, normally top to bottom, using a defined tool. Each link includes the name of the webpage 405 along with a header providing the webpage title, which typically doubles as an Internet link. Below the webpage 405, a link 404 allows a user to add the link to the MyBookmark list 500. An icon 406 is added or can substitute the link 404. In one embodiment, the sequential ordering of the pages returned by the search engine of MySearch is made by using the user-defined data either from the stored files in the MyFiles tab 600 or the data stored in conjunction with the bookmarks in the MyBookmark tab 500.

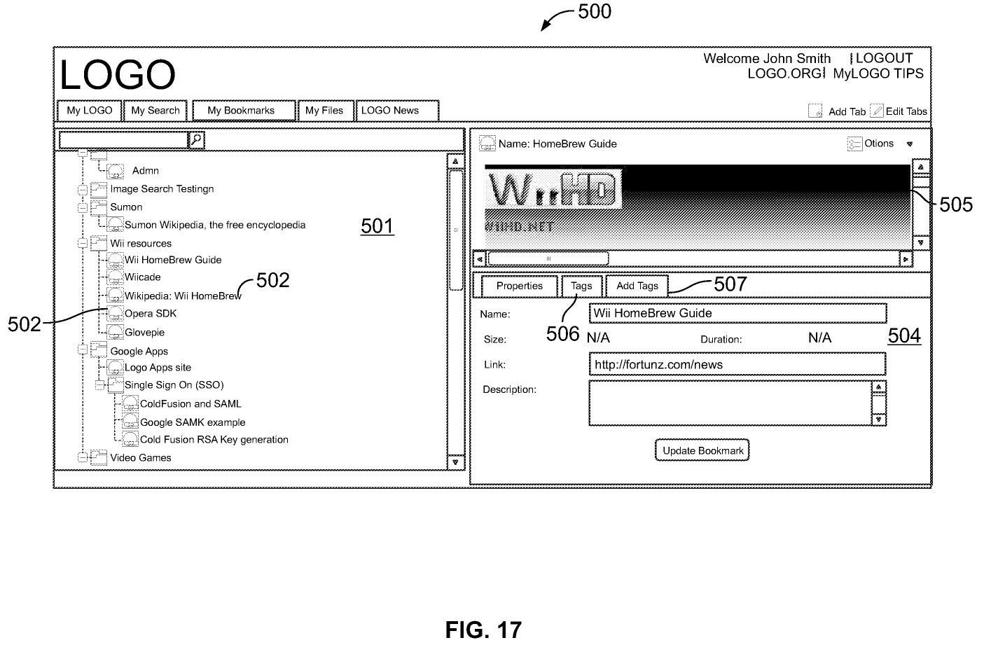

FIG. 4 is a webpage illustrating the MyBookmarks tab 500 of a personalized, online, scientific interface 100 according to an embodiment of the present disclosure. Bookmarks are stored and displayed in an embodiment using a tree structure 505 where files 506, 503 are stored in subdirectories 504. The bookmarks can be associated with files, websites, pages of a presentation, notes, search results in general, or any displayed item that can be accessed using the personalized, online, scientific interface 100. Icon 502 is used to alter the display of the bookmarks from a simple tree structure to any possible configuration, including but not limited to a dual screen there the tree structure 501 is displayed on the left portion of the display and on the right an apercu is displayed of any selected item 502 as shown in FIGS. 17-21.

At FIG. 17, a webpage is selected for preview as part of the bookmarks 502. In the right window, a portion of the webpage is rendered 505 and can be viewed using, for example, scroll bars if the display is of insufficient size to display the entire webpage 505. Information regarding the webpage is also displayed 504 using tab menus. Different information, such as the title, the size, duration, and URL, is show along with descriptive data to be entered by a user. Other tabs such as tags 506 or additional tags 507 can also be added manually to provide additional profile information for the webpage 502.

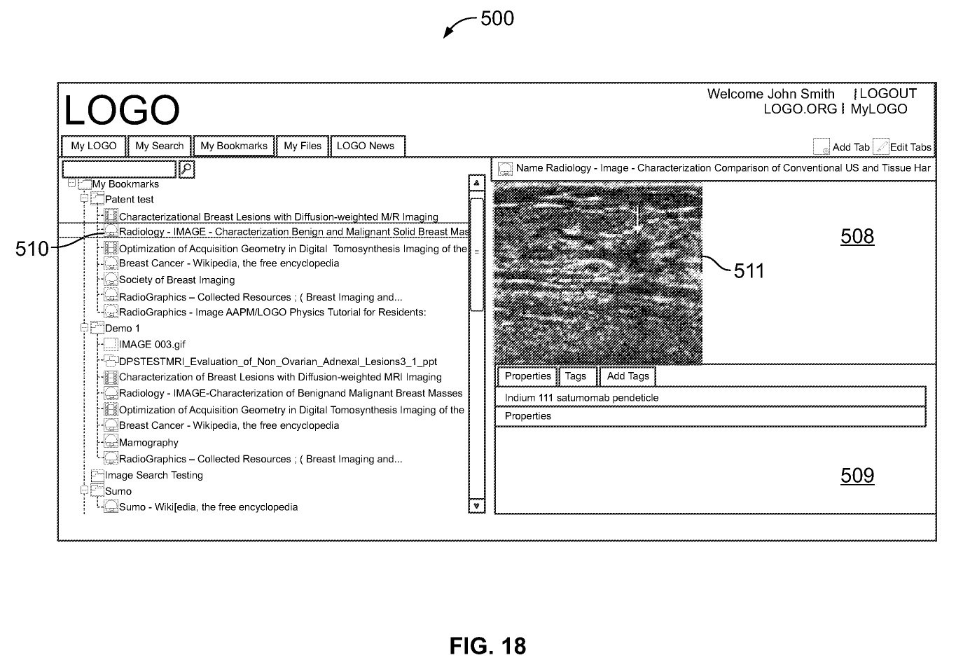

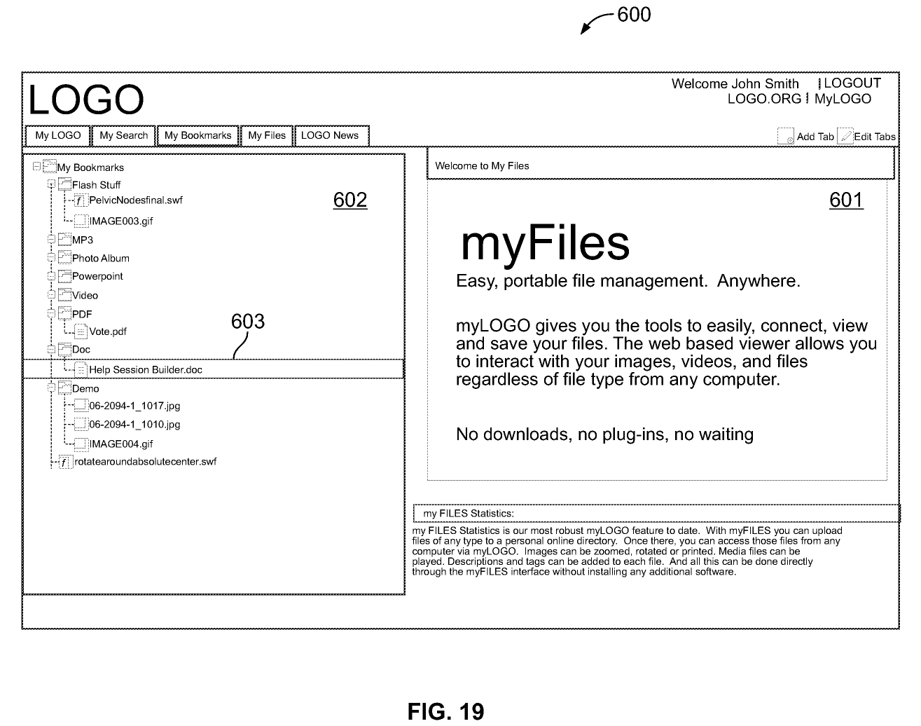

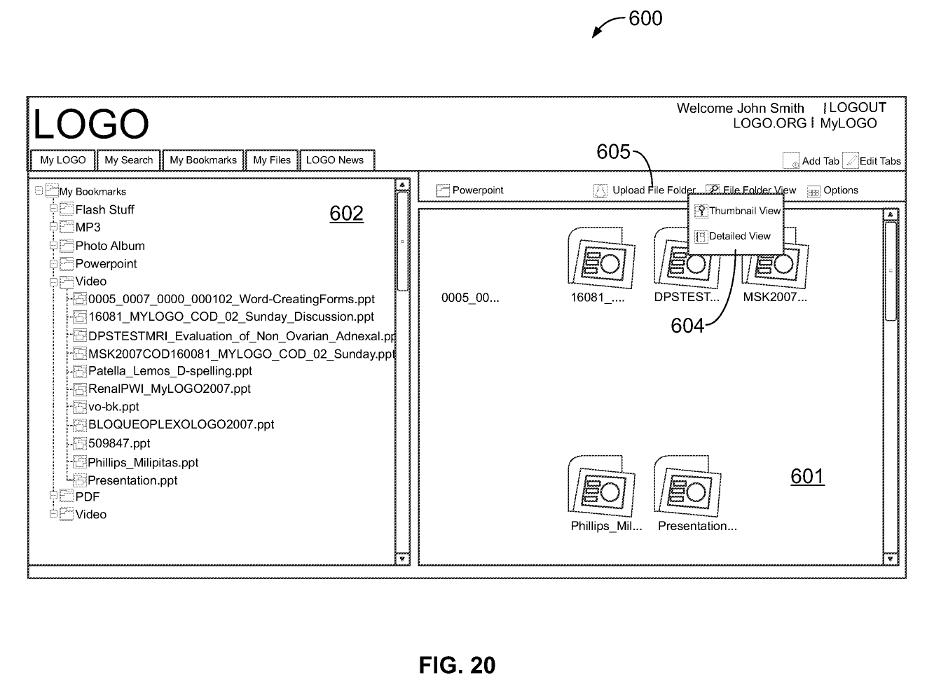

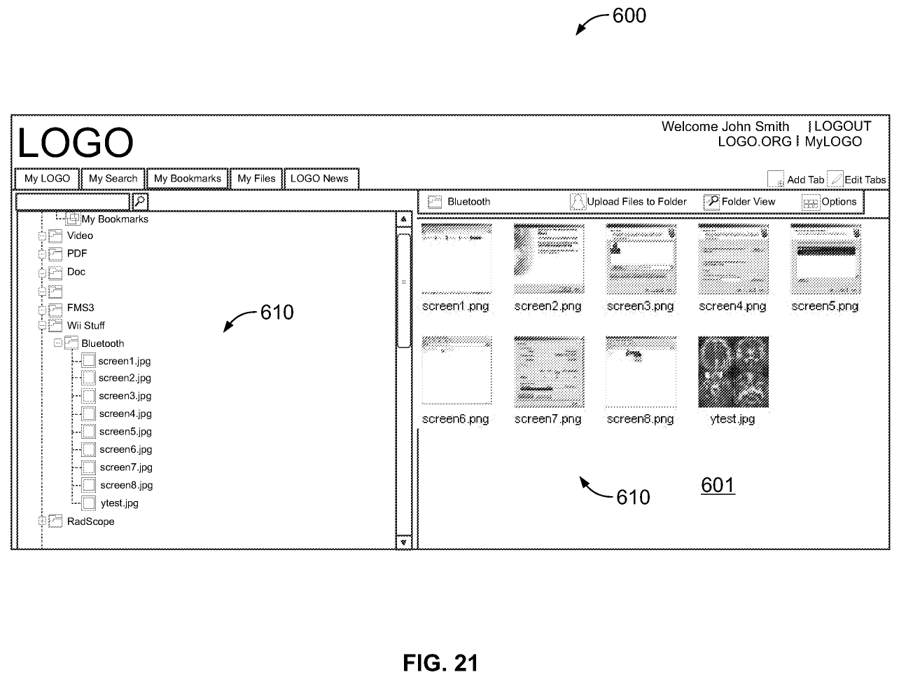

FIG. 18 displays in the right side window 508 an image of the bookmark if the bookmark refers to an image 510. A low-resolution image 511 can be displayed along with a properties window 509. FIG. 19 illustrates a situation where a text file is chosen as a bookmark 603 in the bookmark area 602. The page rendered in the right side window 601 corresponds to a rendered version of the text file using Flash technology. Slide presentations, such as PowerPoint® presentations, if stored as bookmarks as shown in FIG. 20, can be displayed using an icon, a thumbnail view, or a detailed view 604. FIG. 21 shows yet another embodiment where different image files or screen shots can be fully displayed using small, cropped images of the pages as a preview 610. While a handful of embodiments are shown, what is contemplated is the use of any known interface to display to the user over the Internet through a browser a pictorial or nonpictorial representation of the different pieces of data associated with stored bookmarks.

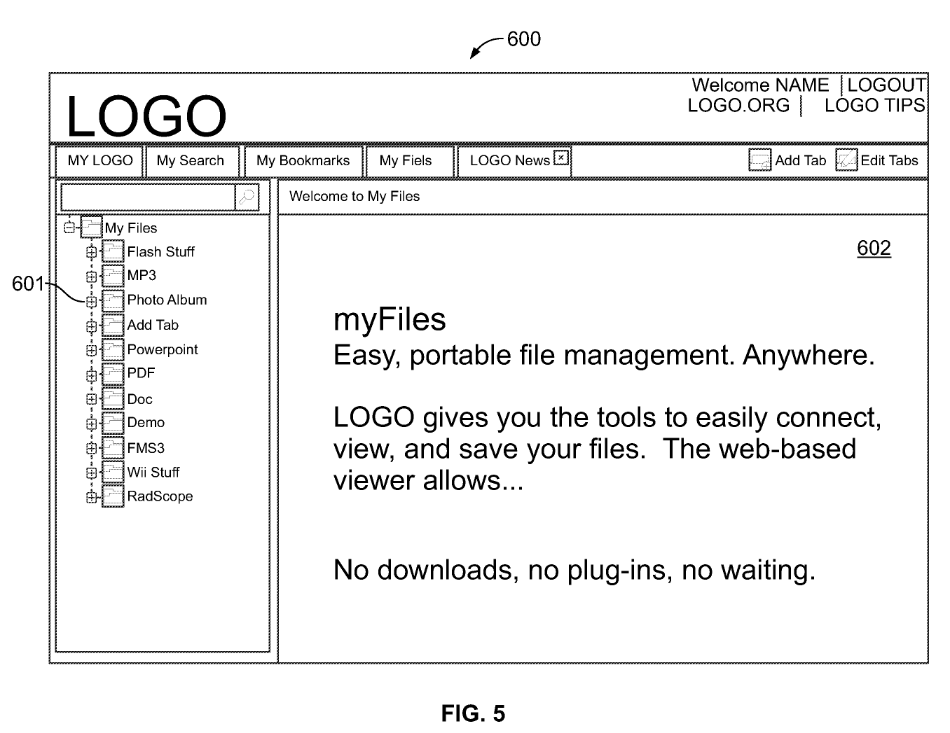

FIG. 5 is a webpage illustrating the MyFiles tab 600 of a personalized, online, scientific interface 100 according to an embodiment of the present disclosure. The different files uploaded and stored within the personalized, online, scientific interface 100 can be displayed, shown, stored, and accessed using the same display management system as shown for the MyBookmarks tab 500 as shown in FIGS. 17-21.

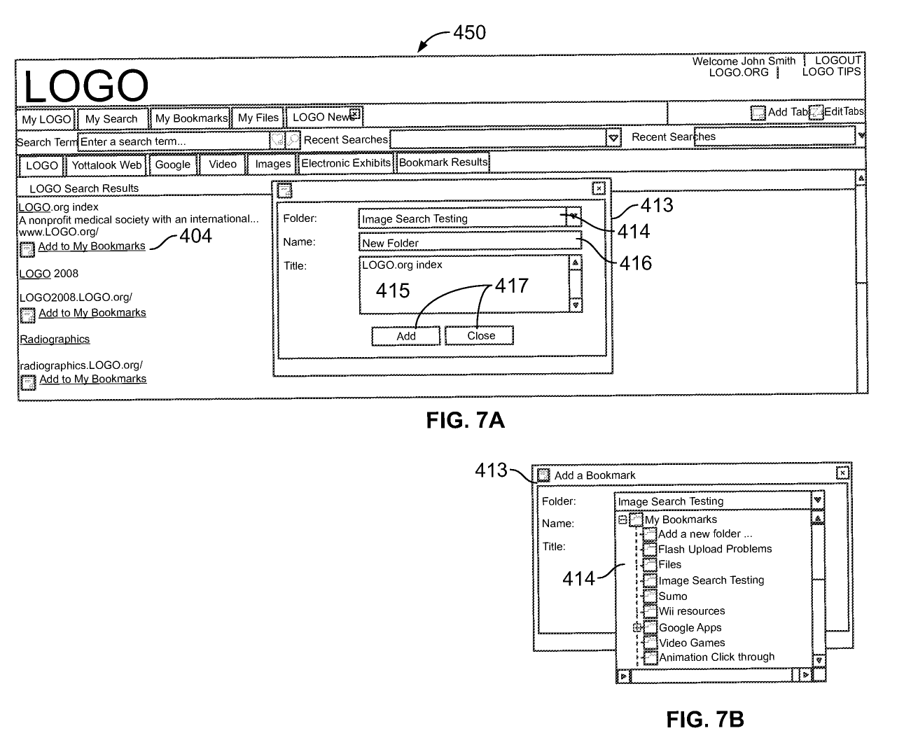

FIG. 7A is an illustration of a pop-up window 413 opened as the result of selecting an “add to my bookmarks” button 404 on the personalized, online, scientific interface 100 according to an embodiment of the present disclosure. This window 413 opens automatically as a result of clicking on the “add to my bookmark” link or button 404. Data such as a title 415, a name 416, or a destination folder 414 can be added using selection buttons 417. The selection of the destination folder 414 results in a pull-down list with scroll bars for the selection of a destination directory or subdirectory as shown in FIG. 7B.

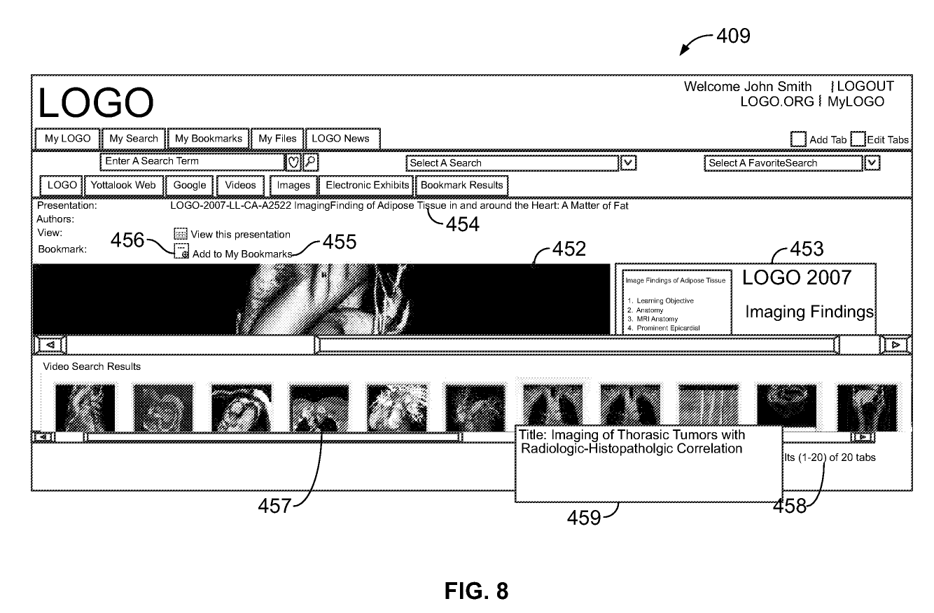

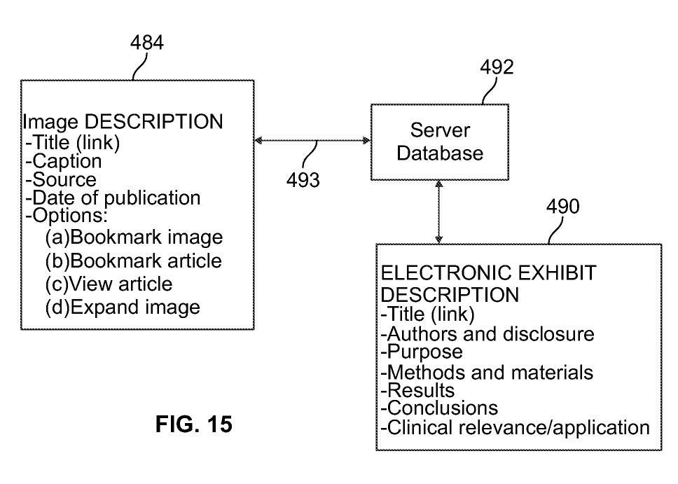

FIG. 8 is an illustration of the webpage displayed as a result of selecting the MySearch tab 400 shown in FIG. 3 and further selecting the video tab 409 on the personalized, online, scientific interface 100 according to an embodiment of the present disclosure and shown in FIG. 3. Unlike webpages, videos must be associated with indexing information to be retrieved and searched. The indexed information is also used on images searched or electronic exhibits instead or in addition to the text contained in the exhibit itself. FIG. 15 illustrates how the indexing information 484 and 490 is transferred to a server database 492 through a link 493 for later access and search. The indexing information of a video or an image 484 includes a description, a title in the form of a dynamic link, a caption, a source, a date of publication, a selection to bookmark the image or video, to bookmark the entire article or data in which the video or image is found, a selection to view the article, and a selection to expand the video or image for view of high resolution images or videos.

Electronic exhibits indexing information 490 can include a description, a title in the form of a dynamic link, the authorship and the associated disclosure, the purpose of the exhibit, the methods and materials used during the test resulting in the exhibit, the results of the testing, the conclusions drawn by the author, or even the clinical relevance and the application associated with the exhibit.

Returning to FIG. 8, the search results are shown from left to right 457 where a thumbnail of each is displayed instead of being arranged sequentially from top to bottom. Tools such as a pop-up box with the title of an image can be shown 459 if a cursor is hovered over an image in the search result. The display also includes the display of key information associated with a selected image, such as the title of the presentation 454, the authors, or icons to view the presentation or add the image to the bookmarks 456 or associated dynamic web links 455.

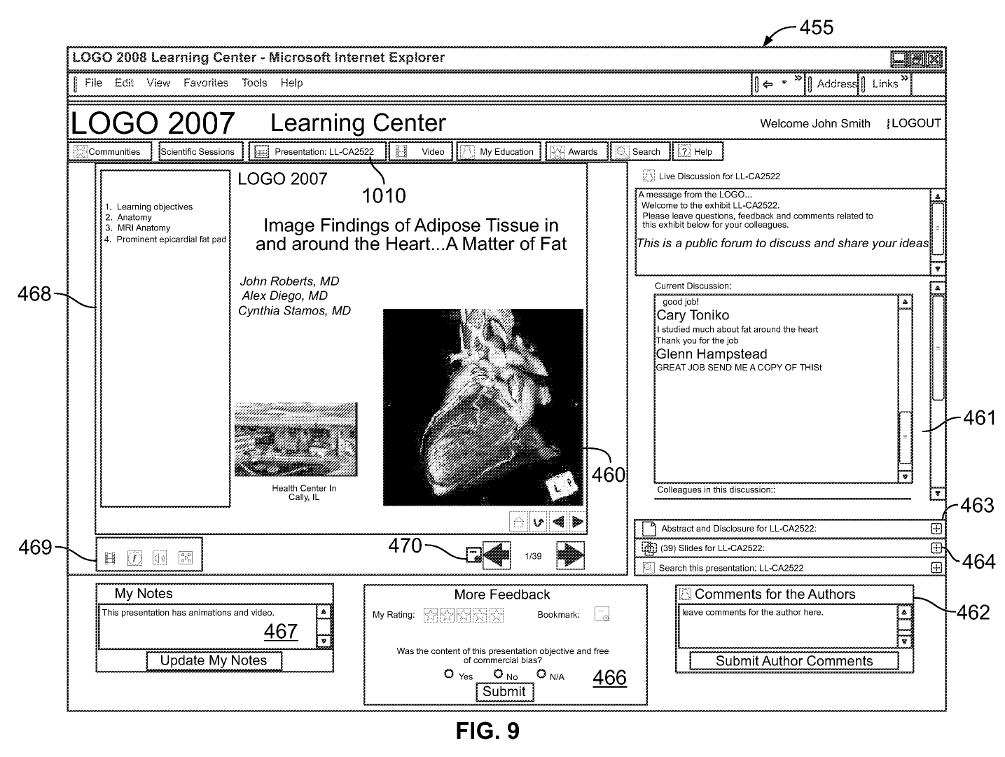

If the image is a slideshow or a presentation, the user may use the “view this presentation” link or the associated icon to launch a digital presentation system 455 as shown in FIG. 9. In one embodiment, this system opens in a different window. The digital presentation system 455, much like the personalized, online, scientific interface 100, is described as a series of horizontal tabs for accessing different functions in the software. For both the digital presentation system 455 and the personalized, online, scientific interface 100, the use of horizontal tabs corresponds only to one of a wide variety of embodiments available to interface programmers.

In one embodiment, a personalized, online, scientific interface 100 as shown in FIG. 2 operates within the memory of a web server 450 as shown in FIG. 36 connected to a user browser 421 operating on a computer having a processor and memory for executing the browser software through an Internet connection 422. The interface 100 includes a plurality of customized tabs as shown, for example, on FIG. 2 as elements 110, 400, 500, 600, and a plurality of tabs includes at least a personalized interface tab 110 and a personalized search tab 400 where the personalized interface tab 110 includes at least a user profile 120 and an access window to a reference database 130 or 140.

In another embodiment, the personalized interface tab 110 further includes a list of abstracts 170 submitted to an operator of the online scientific interface for approval. The personalized search tab 110 as shown in FIG. 3 may also include at least a tab for displaying search 450 results at a proprietary server, a tab for displaying search results at an application-specific web server 407, and a tab for displaying search results from a general search web server 408. The personalized search tab 110 may also include a tab selected from the group consisting of a video database 409, an image database 410, and electronic exhibit database 411, and a bookmark database 412.

As shown in FIG. 2, the user profile 120, the access window to a reference database 130, 140, and the list of abstracts 170 submitted to an operator of the online scientific interface 10 for approval of the personalized interface tab 110 are arranged within a display surface. The personalized search tab 110 may also include a feature to search previously searched databases 402. In another embodiment, the content displayed in the plurality of tabs is customized based upon a user's knowledge 1009 using icons. The searches conducted within the personalized search tab include a series of dynamic links 405, each for uploading a source of information and wherein each dynamic link further includes an icon for bookmarking 406 the link as part of a personalized bookmark tab 500. Finally, in another embodiment, the information displayed to the browser 421 is converted by a Flash module 1402 at the proprietary server 450 for uploading of an image to the user browser through the Internet 422.

In another embodiment, the tabs of the personalized, online, scientific interface 100 include at least a personalized interface tab 110 and a personalized bookmark tab 500. In yet another embodiment, the tabs of the personalized, online, scientific interface 100 include at least a personalized interface tab 110 and a personalized files folder tab 600.

As shown in FIG. 17, the personalized bookmark tab 500 includes a first display window 501 of a list of a customizable list of bookmarks 502 and a second display window 505 adjacent to the first display window 501 for displaying a preview of a subject matter of any selected bookmark from the first display window alongside a profile of the bookmark 504. The profile 504 may include at least a name of the bookmark and a dynamic link of a storage location of the selected bookmark displayed in the second display window. The content displayed in the plurality of tabs of the personalized, online, scientific interface 100 is customized based on a user's knowledge using icons 111.

The personalized file folder tab 600 includes a third display window 601 of a list of files uploaded to a server for storage and a fourth display window 602 adjacent to the third display window 601 for displaying a preview icon of a subject matter of any selected file within a directory from a chosen file from the third display window.

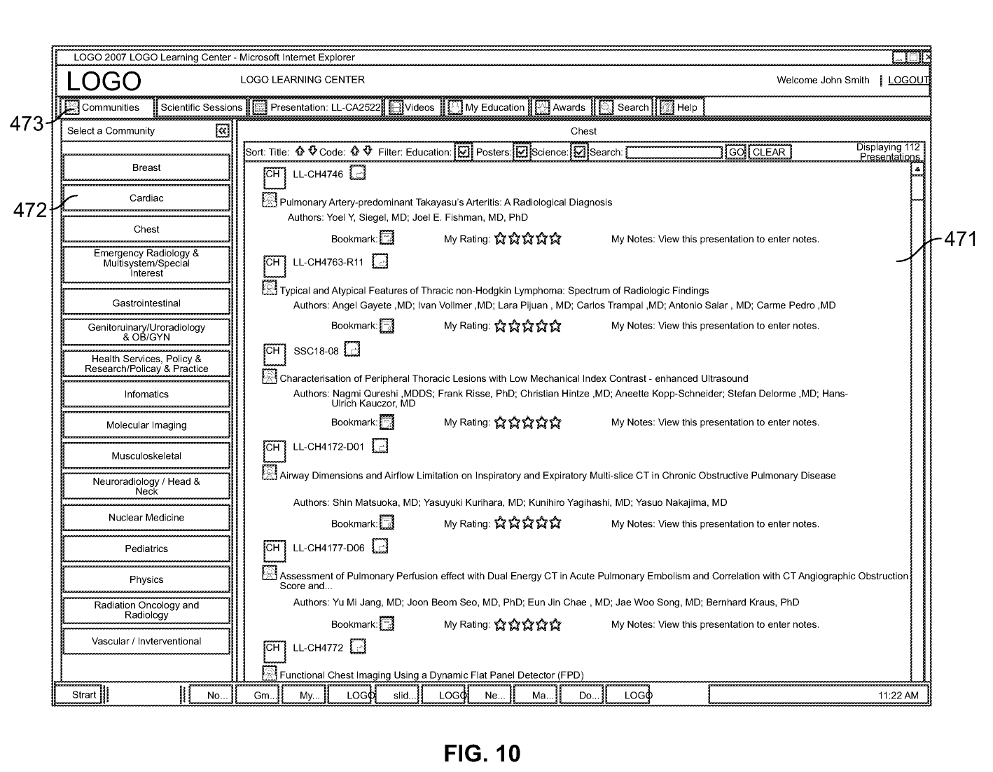

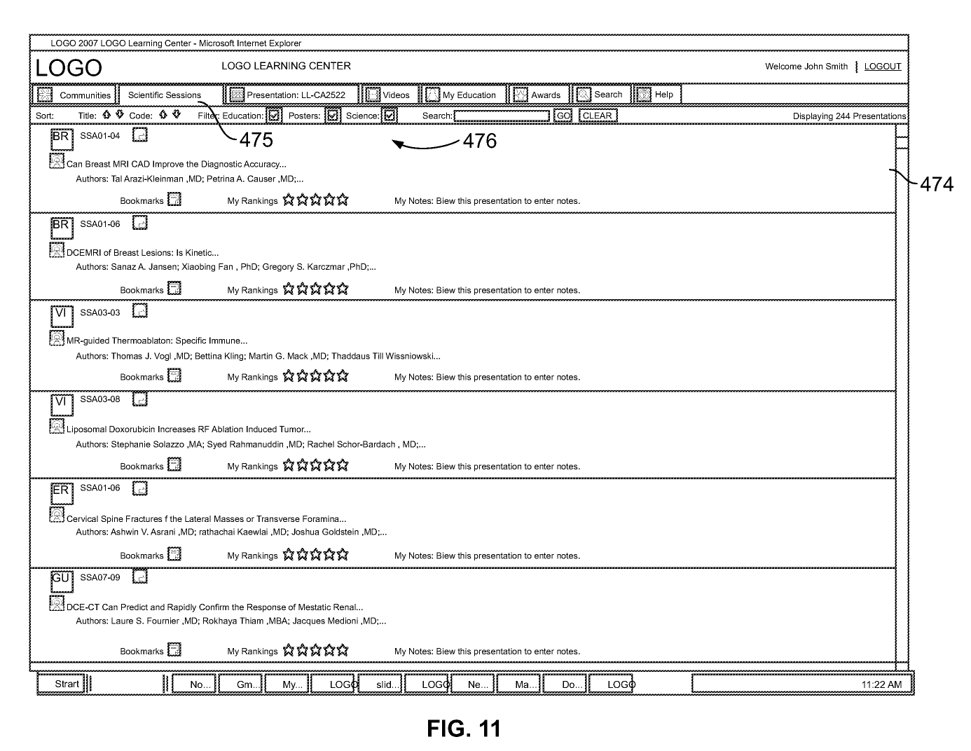

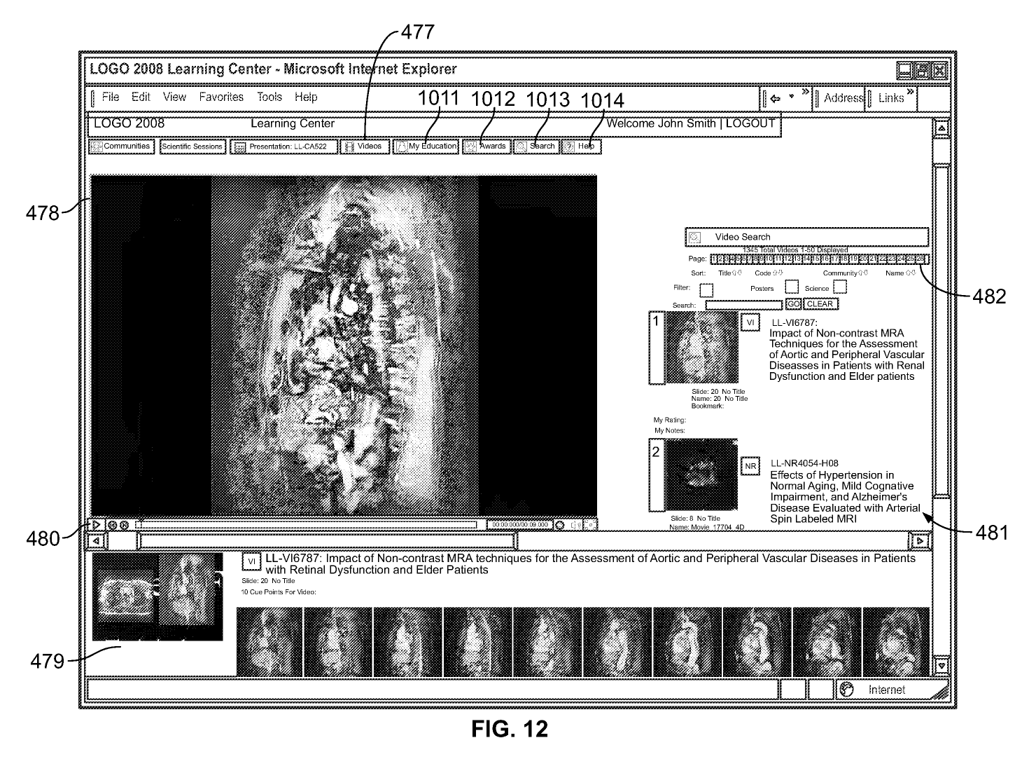

FIG. 9 shows the digital presentation system 455 with a view of the third tab from the left the presentation tab 1010. FIG. 10 illustrates the webpage display associated with the first communities tab 473, FIG. 11 illustrates the webpage display associated with the second tab, the scientific sessions tab 475, and FIG. 12 represents the fourth video tab 477. The other tabs as shown, such as the My Educator tab 1011, the Awards tab 1012, the Search tab 1013, and the Help tab 1014, each relate to functions defined by their respective names.

Returning to FIG. 9, a main window 460 displays one page of a presentation along with toolbars 470 and tools for navigating between the different successive slides of the presentation. Icons 469 are also available to change the display from a single slide presentation to a multislide presentation, to change the sound, or even run videos when desired. What is also shown in a vertical bar 468 on the left of the Flash image illustrating one page of the presentation 460 where a small slide summary can be displayed, or the title of each slide to help with the presentation. While one display technology is shown, what is contemplated is the use and display of any known display technology associated with slide presentations. The main window 460 is surrounded in the given example by a series of smaller windows 461 to 467 either opened as shown by windows 461, 462, 466, and 467 or compressed as shown by windows 463-465.

The digital presentation system 455 may be used at large venues by a remote or live participant. Window 461 is a live discussion tool with a scroll window for display of the ongoing conversation with other attendees of the presentation given by a presenter, a header box and a link to list and contact the different colleagues currently in the discussion. Window 462 is a tool for entering and sending to an author or a presenter of the slide presentation 460 feedback and comments that may be viewed or accessed either by the presenter or by some or most of the attendees.

Window 466 is a tool for giving the presentation 460 and the associated presenter a measured importance, including, for example, using a rating, bookmarking the presentation, or answering questions asked of the attendees for survey or academic currency purposes. A tool for entering notes 467 is shown. This function allows an attendee to place or associate in a stored version of the presentation specific notes on each slide or general notes on the presentation. While a plurality of other windows can be added to the digital presentation system 455, window 463 is an area where the abstract of the presentation can be shown, window 464 is a slide list of the presentation, and window 465 is a search tool for the indexed information of the presentation.

FIG. 10 is a webpage illustration of the Communities webpage displayed once the Communities tab 473 is pressed on the webpage shown in FIG. 9 according to an embodiment of the present disclosure. When a great number of abstracts are uploaded and ultimately lead to a large number of presentations to be shown at a single venue, different presentations can be distributed in different categories 472 as part of a community 473. For example, the digital presentation system 455 for a medical seminar on radiology can hold presentations directed to breast, cardiac, or chest radiology, etc. An attendee who specializes in breast radiology selects the radiology tab and reviews in the open space 471 the different presentations available either at a selected time in the venue or the presentations that can be run online at the user's convenience. In the open space 471, several summaries of presentations can be seen. The first illustrated as LL-CH4746 is described as a presentation on the pulmonary artery-predominant Takeyasu's arteritis: A Radiological Diagnosis. The authors are then listed and an icon is provided to bookmark the presentation in the MyBookmark 500 area of the personalized, online, scientific interface 100. The rating and notes entered by the user are also shown once a user has viewed the presentation and filled in the windows 466 and 467 as shown in FIG. 9.

FIG. 11 is a webpage illustration of the Scientific Sessions webpage displayed once the Scientific Session tab is pressed on the webpage shown in FIG. 9 according to an embodiment of the present disclosure. Scientific sessions are a different way for a venue to organize and group a series of presentation aside from the communities shown in FIG. 10. Finally, the digital presentation system 455 also includes a tab to display videos 477 found in the different presentations within the system 455. This indexing allows users to quickly browse the presentations for images of interest to determine whether attendance or participation at a specific presentation is worthwhile. The display includes a page indexer 482, a list of search hits shown sequentially 481, and a display of subsequent slides 479 of a selected video 478.

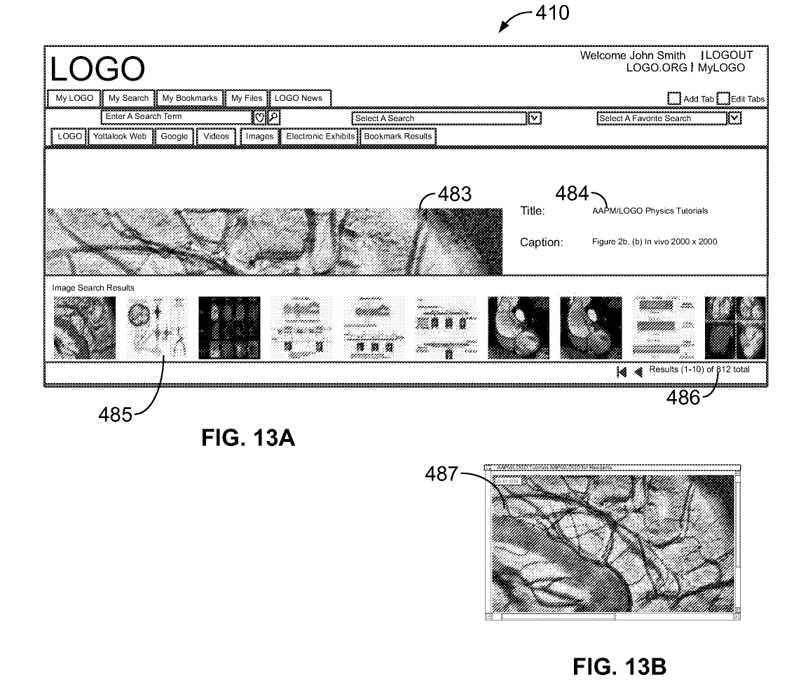

Returning to FIGS. 13A and 13B, FIG. 13A is a webpage illustration of the webpage displayed as a result of selecting the MySearch tab 400 shown in FIG. 3 and further selecting the Image tab 410 on the personalized, online, scientific interface 100. Much like videos can be searched, images can be similarly searched and displayed with greater resolution as shown in FIG. 13B.\

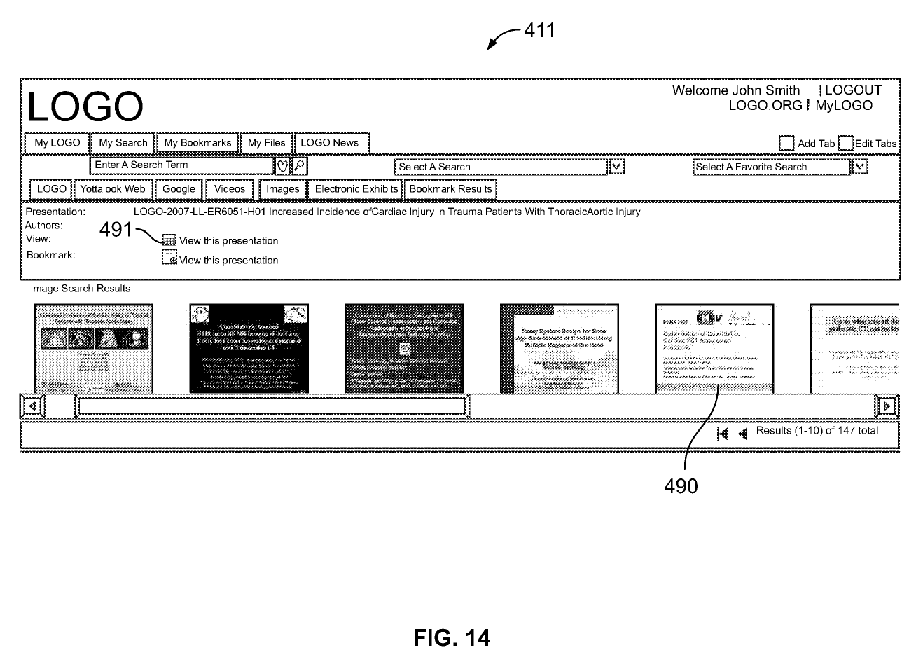

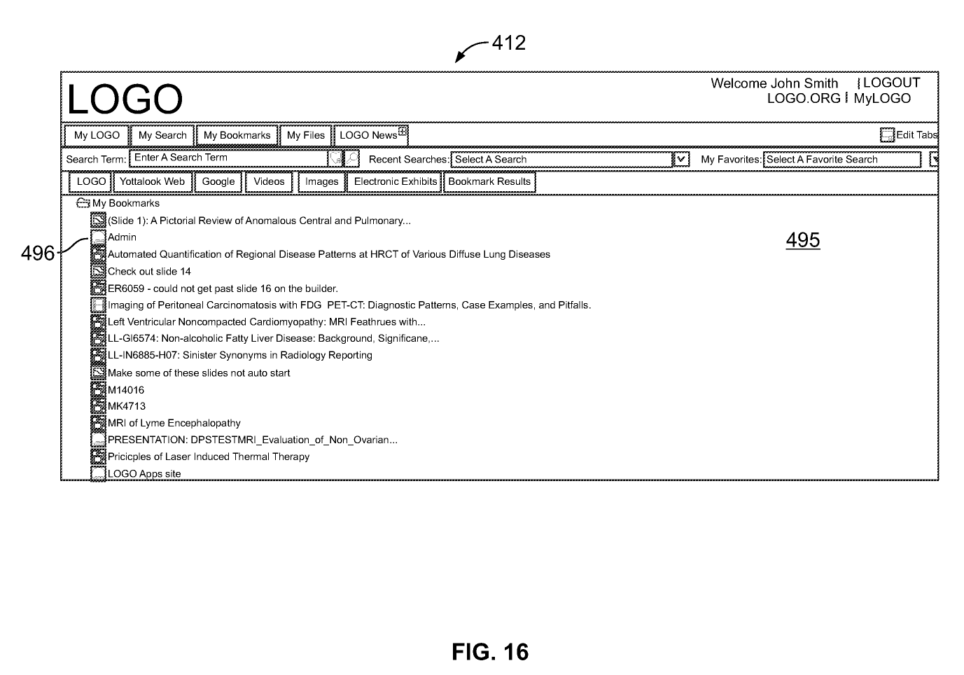

FIG. 14 is an illustration of the webpage displayed as a result of selecting the MySearch tab 400 shown in FIG. 3 and further selecting the Electronic Exhibit tab 411 on the personalized, online, scientific interface 100 according to an embodiment of the present disclosure. The same type of interface is used where the first page of the electronic exhibits are shown 490. A dynamic link and an icon 491 allow the user to launch the digital presentation system 455 shown in FIG. 8. FIG. 16 is a representation of the webpage displayed as a result of selecting the MySearch tab 400 shown in FIG. 3 and further selecting the Bookmark Results tab 412 on the personalized, online, scientific interface according to an embodiment of the present disclosure.

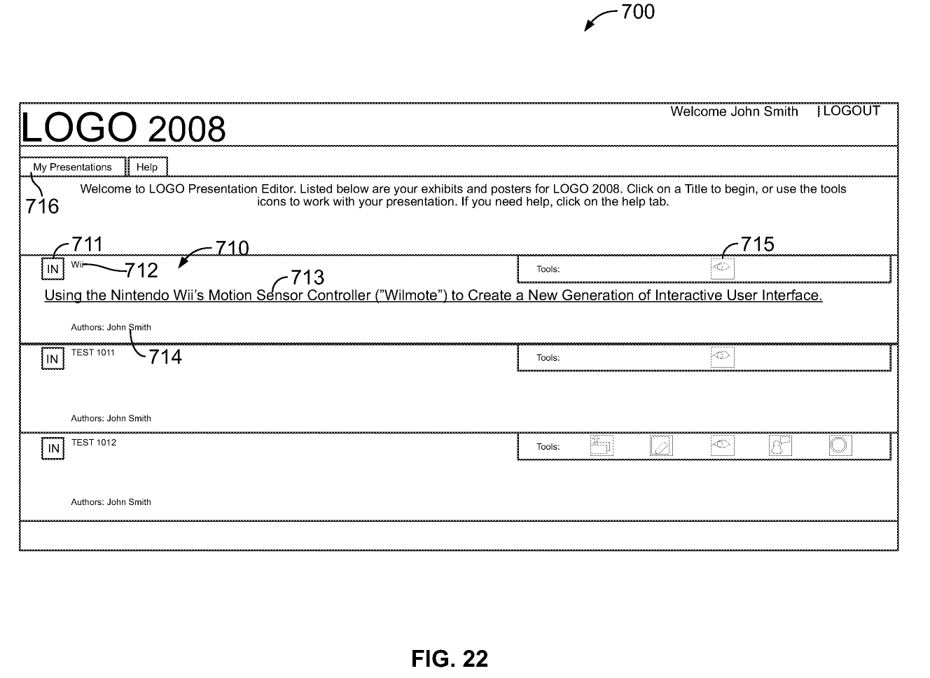

As part of the personalized, online, scientific interface 100, abstracts from users can be monitored using window 170 as shown in FIG. 2. Within the process of gaining academic currency, such as, for example, gaining public recognition by the scientific community, a plurality of abstracts on different topics are uploaded by a user who may already know and use the personalized, online, scientific interface 100 described above and have knowledge of the digital presentation system 455 when attending conferences in person or remotely. The different presentations are uploaded for later display to peers or publication using paper-based publications, Internet diffusion, or diffusion via the digital presentation system 455 described above. Abstracts are uploaded and evaluated by peers through a process described hereafter and illustrated in FIGS. 22-35.

In an embodiment shown at FIG. 9, a digital presentation system 455 is operating within the memory of a proprietary web server 450 connected to a user browser 421 through an Internet connection 422, the system producing HTML pages as shown in FIGS. 1-3 for displaying on a display (not shown) of the computer of a user using an Internet browser compatible with the HTML format HTML pages with a Flash image 460 of a slide generated from a slide presentation, a toolbar for navigating the slide presentation 470 and display of different Flash images of the slide presentation, and a live discussion tool 461 for interacting with other users over the Internet about the Flash image 460. The HTML pages further include a tool for entering notes 467 relating to the Flash image wherein these notes are stored in the memory of the proprietary web server 450.

The digital presentation system 455 also includes a tool for entering and sending to an author of the slide presentation feedback comments 462. Attendees can also communicate with each other and interact with the authors. In another embodiment, the digital presentation system 455 further includes a tool for giving a slide a measured importance for later archiving and retrieval 466, and a tool for giving a rating to the slide presentation. The text shown on the Flash image 460 is used as an indexing text of the Flash image, and the system further includes a tool for searching the text as described above.

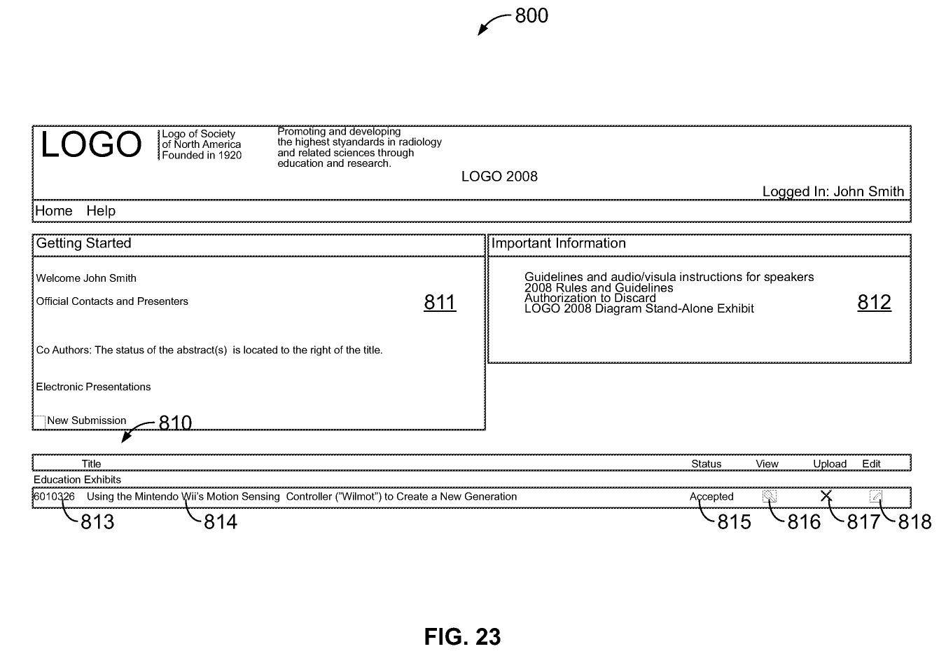

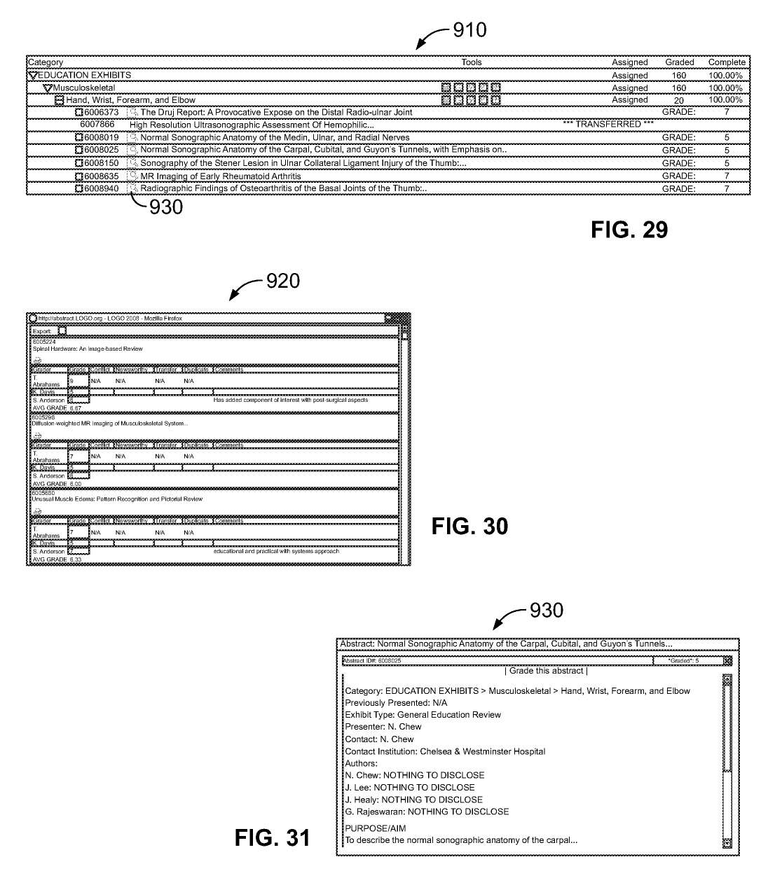

A method associated with this process is shown as FIG. 37. A user can either log into a personalized portal with submission 1404 such as the personalized, online, scientific interface 100, or simply log into a submission portal 1403. This author is then granted permission to upload an abstract for submission 1405 through the portal as shown in FIGS. 23-28. Based on the nature and subject of these abstracts, they are then assigned by group coordinators to evaluators 1406 via a peer review process. FIGS. 29-34 illustrate this process. The abstract is then either rejected or accepted and the status is then changed on the abstract window 170 on the personalized, online, scientific interface 100.

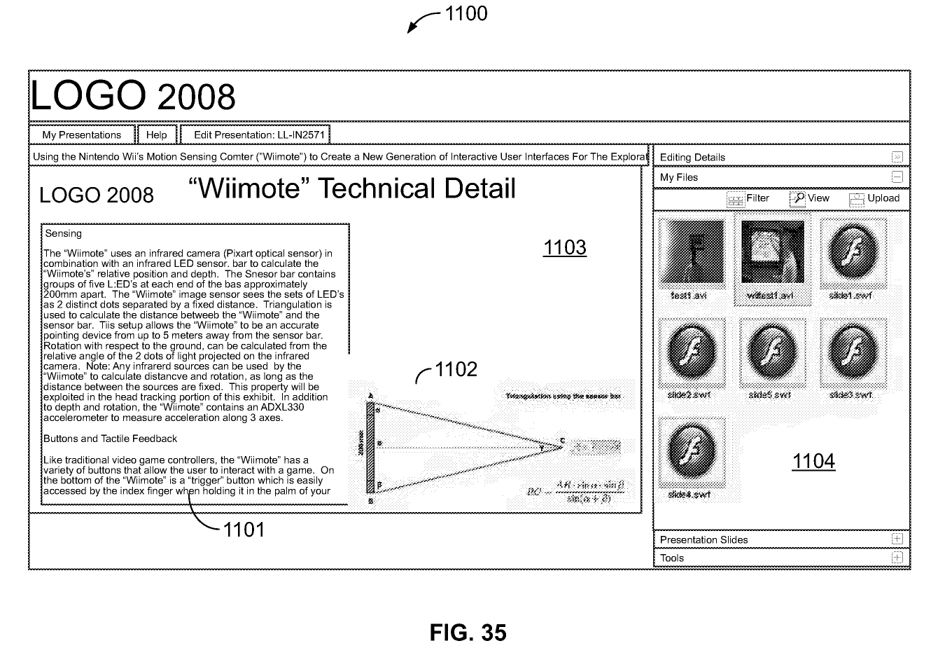

If and when accepted, the author or authors are then invited to enter the body of the presentation 1407 using an interface as shown in FIG. 35. Once the presentation is completed, it is sent for either publication or presentation at a venue. The digital presentation system 455 can be used to present the presentation 1408. The digital presentation system 455 is connected via the Internet to remote attendees and to local computers located in the different rooms at the venue. A venue management tool 1408 allows for the management of rooms, the publication to peers 1412, the evaluation over time of the academic currency of a presenter 1411, and ultimately a wide range of reporting data 1410 to the presenter. For example, the attendance, the general ratings given, the locations of the attendees around the world, and the associated feedbacks can be reported to the presenter.

The interface 1100 used to build a presentation from an abstract is shown in FIG. 35. Users may also use resident software to prepare the presentation and upload the finished product. In FIG. 35, a window to the left allows users to click-and-drag files from a database 1104 into an area 1103 defined as a slide. Images, equations 1102, videos, or any other media can be uploaded directly onto the page 1103. Text 1101 can also be added. Menus for editing effects, files, filters, slides, and tools can also be used to help in the creation of finished presentation.

FIG. 22 is a representation of the home webpage of a presentation editor 700 for working with and evaluating a presentation or an abstract in the online scientific interface 100 according to an embodiment of the present disclosure. Under the My Presentations 716 tab, a user selects an abstract to be edited into a full presentation. FIG. 22 illustrates a situation where a single abstract 710 is found and can be selected by pressing the dynamic link 713. An icon 715 allows a pop-up window to display the abstract as shown in FIG. 31. Authors are listed 714 and other reference identifiers can be added 711, 712 to help the interface classify and store the abstract in the digital presentation system 455.

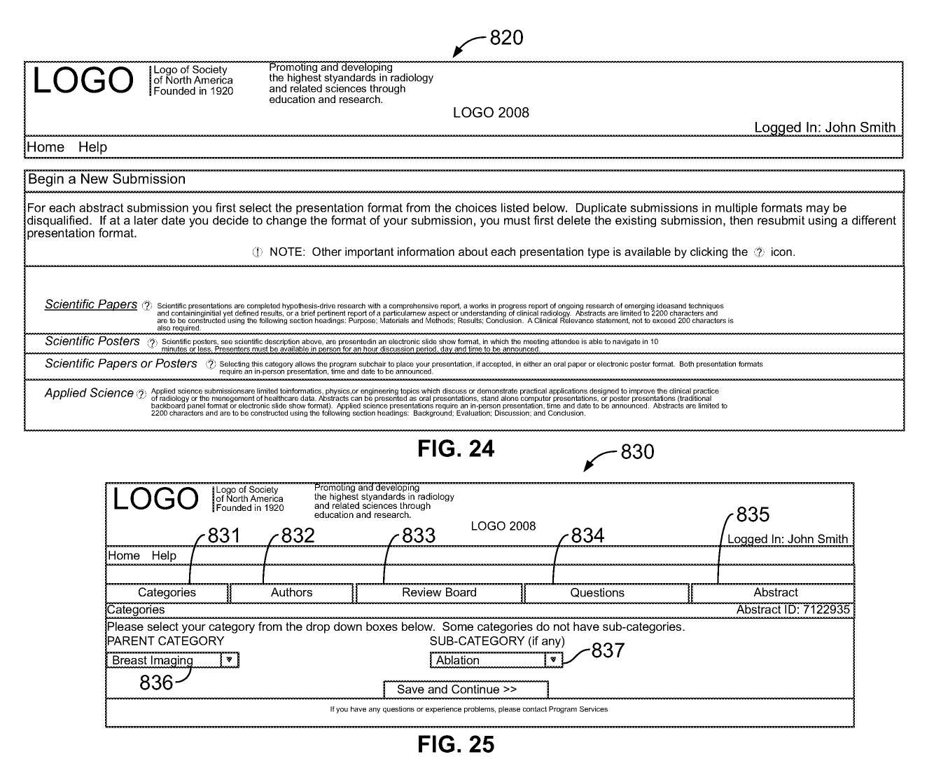

Once the abstract is chosen, FIG. 23 illustrates a page with information 811 and important guidelines for drafting the presentation according to needed specifications 812. A bar 810 allows for a quick overview of the abstract by listing from left to right the reference identifiers of an educator 813, a title 814, a status 815, a “view” button 816, an “upload” button 817, and an “edit” button 818. FIG. 24 shows a first webpage with a description of the different types of papers to be submitted for classification of the presentation 820.

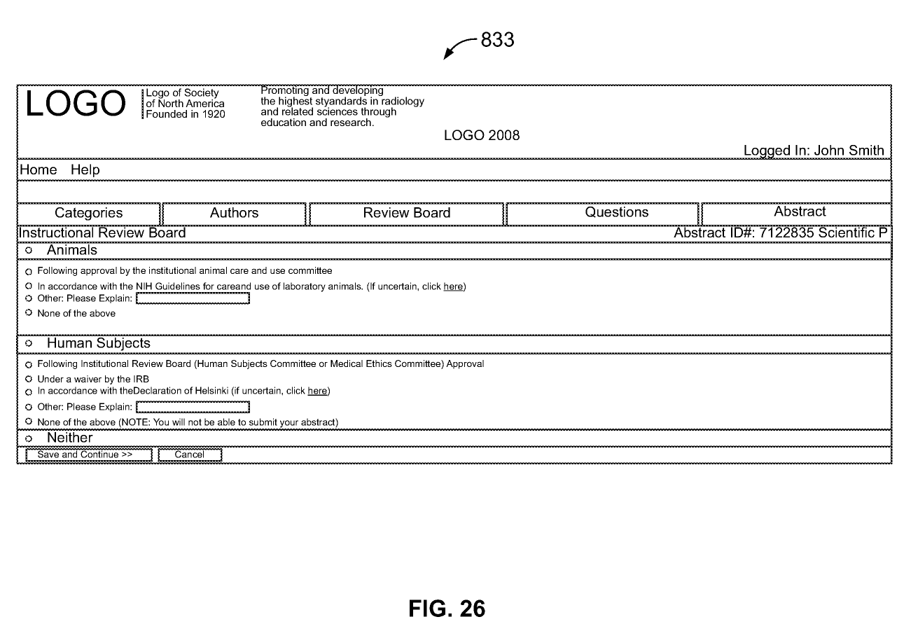

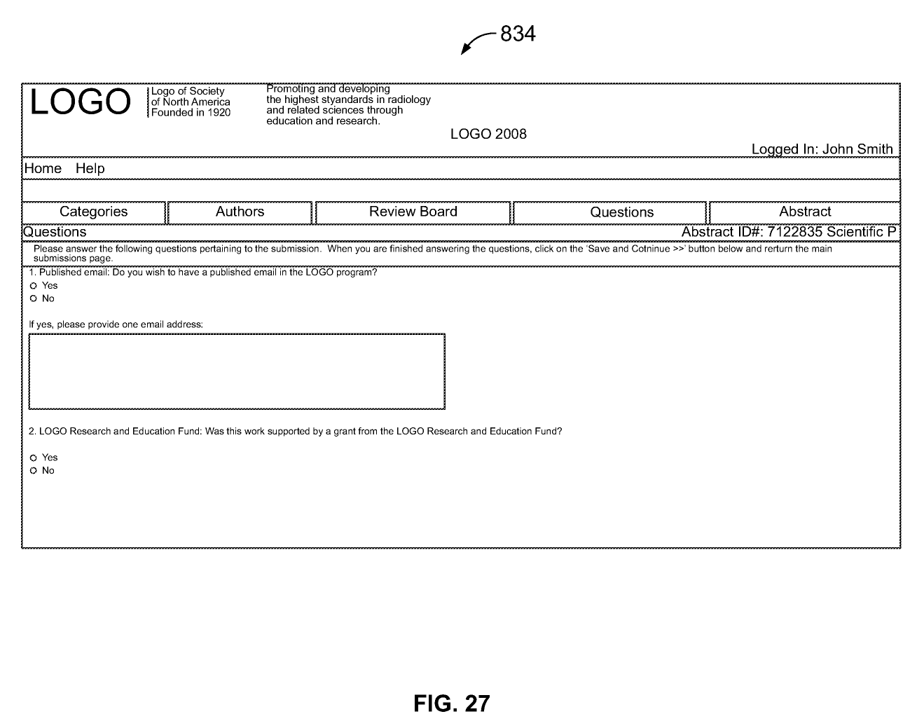

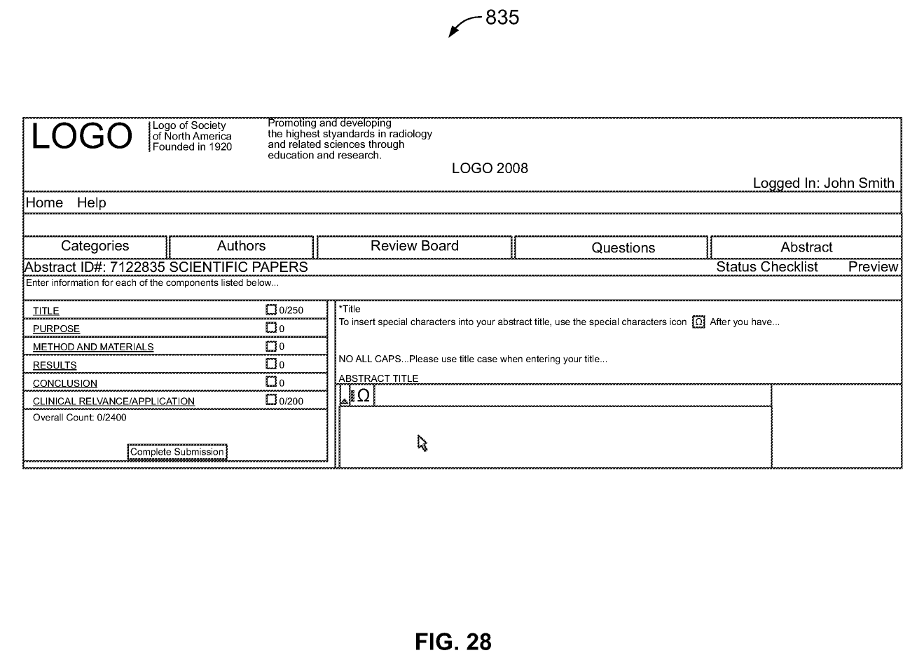

FIG. 25 shows different horizontally arranged tabs for entering the type of category 831 with both a parent category 836 and a subcategory 837, an author tab 832 for entering and designating the authorship of the presentation and a review status 833, a question tab 834, and a tab where the abstract can be accessed 835. At the review board status 833, different questions may be presented to the author as shown at FIG. 26, and at the Questions step 834, different questions of general interest may be asked as shown in FIG. 27. FIG. 28 shows a summary dashboard for submitting the different portions of the presentation, namely, the title, the purpose, the method and materials, the results, the conclusion, and the clinical relevance/application.

Peer reviewers are then assigned abstracts for review and grading to determine if they are to be passed for full presentation or denied. FIGS. 29-34 show illustrations of this process. In FIG. 29, a handful of abstracts 930 are illustrated on different rows of the table and are assigned and graded. For example, at FIG. 29, the percentage of completion of the musculoskeletal abstracts assigned is 100%. The interface lists 160 abstracts in this subcategory. Next to each abstract, the grade is given. By selecting a tool from the small tool area at FIG. 29, the table of FIG. 30 is opened. Each graded abstract is then described 920 using the grade for one or a plurality of graders, the existence of conflicts, the newsworthiness of the topic, the possible transfer, or duplicate nature of the abstracted information. An average grade is then calculated for each abstract.

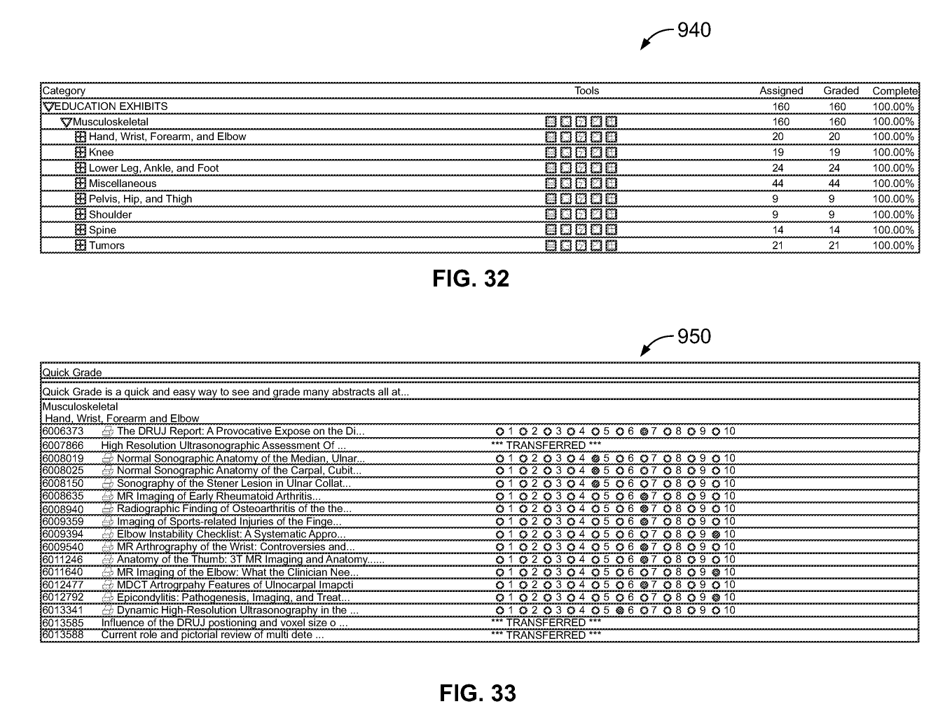

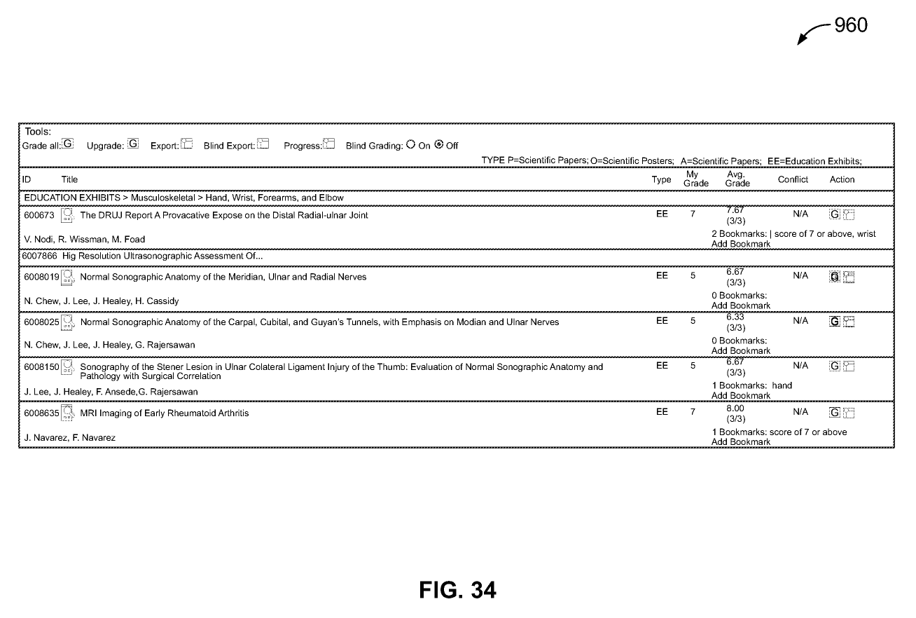

FIG. 32 shows a breakdown 940 of all abstract in a category, such as musculoskeletal. FIG. 33 shows a possible grid 950 used to give rapid grading from 1 to 10 to each abstract. FIG. 34 shows in a summary table how each abstract can be graded and presented in rows. A grader is able to compare his grade with the average grade given by other graders for each of the abstracts graded.

In one embodiment, a method is contemplated having the steps of providing an integrated online interface 1404 as shown in FIG. 37 for allowing an author to submit an abstract 1405, then giving access to peers for the review of the abstract 1406, followed by allowing the author to enter the body of the presentation 1407, and finally, presenting the presentation to peers 1408. Subsequent steps includes providing a venue management tool 1409 for managing the presentation given by a plurality of authors each with a different presentation to peers in a venue and reporting 1410 to each author data associated with the presentations given at the venue.

In an alternate embodiment, the method further comprises the step of providing a venue management tool 1409 that includes providing an academic currency report 1411. The step of submitting the abstract 1405 by the author may be preceded by the step of logging into a personalized portal 1404 with submission links or logging into a submission portal 1403. The venue management tool may also further comprise a step of awarding at least one presentation with an excellence award (not shown).

Persons of ordinary skill in the art appreciate that although the teachings of this disclosure have been illustrated in connection with certain embodiments and methods, there is no intent to limit the invention to such embodiments and methods. On the contrary, the intention of this disclosure is to cover all modifications and embodiments falling fairly within the scope the teachings of the disclosure.

What is claimed is:

1. A personalized, online, scientific interface operating within the memory of a web server connected to a user browser through an Internet connection, the interface comprising a plurality of customized tabs, wherein the plurality of tabs includes at least a personalized interface tab and a personalized search tab, wherein the personalized interface tab includes at least a user profile and an access window to a reference database.

2. The personalized interface of claim 1, wherein the personalized interface tab further includes a list of abstracts submitted for approval to an operator of the online scientific interface.

3. The personalized interface of claim 1, wherein the personalized search tab comprises at least a tab for displaying search results at a proprietary server, a tab for displaying search results at an application specific web server, and a tab for displaying search results from a general search web server.

4. The personalized interface of claim 3, wherein the personalized search tab further comprises a tab selected from the group consisting of a video database, an image database, an electronic exhibit database, and a bookmark database.

5. The personalized interface of claim 2, wherein the user profile, the access window to a reference database, and the list of abstracts submitted for approval to an operator of the online scientific interface of the personalized interface tab are arranged within a display area.

6. The personalized interface of claim 4, wherein the personalized search tab includes a feature to search previously searched databases.

7. The personalized interface of claim 1, wherein a content displayed in the plurality of tabs is customized based upon a user's knowledge of the interface.

8. The personalized interface of claim 1, wherein searches conducted within the personalized search tab include a series of dynamic links, each for uploading a source of information and wherein each dynamic link further includes an icon for bookmarking the link as part of a personalized bookmark tab.

9. The personalized interface of claim 3, wherein the information displayed is converted by a Flash module at a proprietary server for uploading of an image to the user browser through the Internet.

10. A personalized, online, scientific interface operating within the memory of a web server connected to a user browser through an Internet connection, the interface comprising a plurality of customized tabs, wherein the plurality of tabs includes at least a personalized interface tab and a personalized bookmark tab, wherein the personalized interface tab includes at least a user profile and an access window to a reference database.

11. The personalized interface of claim 10, wherein the personalized interface tab further includes a list of abstracts submitted for approval to an operator of the online scientific interface.

12. The personalized interface of claim 11, wherein the user profile, the access window to a reference database, and the list of abstracts submitted for approval to an operator of the online scientific interface of the personalized interface tab are arranged within a display area.

13. The personalized interface of claim 11, wherein the personalized bookmark tab includes a first display window of a list of a customizable list of bookmarks and a second display window adjacent to the first display window for displaying a preview of a subject matter of any selected bookmark from the first display window alongside a profile of the bookmark.

14. The personalized interface of claim 13, wherein the profile includes at least a name of the bookmark and a dynamic link of a storage location of the selected bookmark displayed in the second display window.

15. The personalized interface of claim 10, wherein a content displayed in the plurality of tabs is customized based upon a user's knowledge of the interface.

16. A personalized, online, scientific interface operating within the memory of a web server connected to a user browser through an Internet connection, the interface comprising a plurality of customized tabs, wherein the plurality of tabs includes at least a personalized interface tab and a personalized files folder tab, wherein the personalized interface tab includes at least a user profile and an access window to a reference database.

17. The personalized interface of claim 16, wherein the personalized interface tab further includes a list of abstracts submitted for approval to an operator of the online scientific interface.

18. The personalized interface of claim 17, wherein the user profile, the access window to a reference database, and the list of abstracts submitted for approval to an operator of the online scientific interface of the personalized interface tab are arranged within a display area.

19. The personalized interface of claim 17, wherein the personalized file folder tab includes a third display window of a list files uploaded into a server for storage and a fourth display window adjacent to the third display window for displaying a preview icon of a subject matter of any selected file within a directory from a chosen file from the third display window.

20. The personalized interface of claim 16, wherein a content displayed in the plurality of tabs is customized based upon a user's knowledge of the interface.

21. The personalized interface of claim 16, wherein searches conducted within the file folder tab includes a series of dynamic links with an icon for bookmarking the links as part of a personalized bookmark tab.

22. A digital presentation system operating within the memory of a proprietary web server connected to a user browser through an Internet connection, the system producing HTML pages for displaying on a display of a user using user browser, the HTML pages comprising:
a Flash image of a slide generated from a slide presentation;
a toolbar for navigating the slide presentation and display a different Flash image of the slide presentation; and
a live discussion tool for interacting with other users over the Internet about the Flash image,
wherein the HTML pages further comprises a tool for entering notes relating to the Flash image, and wherein these notes are stored in the memory of the proprietary web server.

23. The digital presentation system of claim 22, further comprising a tool for entering and sending to an author of the slide presentation feedback comments.

24. The digital presentation system of claim 22, further comprising a tool for giving a slide a measured importance for later archiving and retrieval of important slides.

25. The digital presentation system of claim 22, further comprising a tool for giving a rating to the slide presentation.

26. The digital presentation system of claim 23, wherein the system further creates a report to be sent to the author based on presentation feedback comments.

27. The digital presentation system of claim 22, wherein a text shown on the Flash image is used as an indexing text of the Flash image, and wherein the system further includes a tool for searching the text.

28. A digital presentation system operating within the memory of a proprietary web server connected to a user browser through an Internet connection, the system producing HTML pages for displaying on a display of a user using user browser, the HTML pages comprising:
a Flash image of a slide generated from a slide presentation;
a toolbar for navigating the slide presentation and display a different Flash image of the slide presentation; and
a live discussion tool for interacting with other users over the Internet about the Flash image, wherein a comment can be annotated on the Flash image, and wherein this comment is stored in the memory of the proprietary web server.

29. The digital presentation system of claim 28, further comprising a tool for entering and sending to an author of the slide presentation feedback comments.

30. The digital presentation system of claim 28, further comprising a tool for giving a slide a measured importance for later archiving and retrieval of important slides.

31. The digital presentation system of claim 28, further comprising a tool for giving a rating to the slide presentation.

32. The digital presentation system of claim 29, wherein the system further creates a report to be sent to the author based on presentation feedback comments.

33. The digital presentation system of claim 32, wherein a text shown on the Flash image is used as an indexing text of the Flash image, and wherein the system further includes a tool for searching the text.

34. A digital presentation system operating within the memory of a proprietary web server connected to a user browser through an Internet connection, the system producing HTML pages for displaying on a display of a user using user browser, the HTML pages comprising:
a Flash image of a slide generated from a slide presentation;
a toolbar for navigating the slide presentation and display a different Flash image of the slide presentation; and
a live discussion tool for interacting with other users over the Internet about the Flash image, wherein a HTML page created using the system can be archived in the proprietary web server using a bookmark tab for later retrieval in a personalized interface.

35. The digital presentation system of claim 34, further comprising a tool for entering and sending to an author of the slide presentation feedback comments.

36. The digital presentation system of claim 35, wherein the feedback comments are sent to the author giving a live presentation of the slide presentation via the Internet to a plurality of users.

37. The digital presentation system of claim 34, further comprising a tool for giving a slide a measured importance for later archiving and retrieval of important slides.

38. The digital presentation system of claim 34, further comprising a tool for giving a rating to the slide presentation.

39. The digital presentation system of claim 35, wherein the system further creates a report to be sent to the author based on presentation feedback comments.

40. The digital presentation system of claim 34, wherein a text shown on the Flash image is used as an indexing text of the Flash image, and wherein the system further includes a tool for searching the text.

41. A method for promoting the transfer of scientific know-how comprising the steps of:
providing an integrated online interface for allowing
(a) an author for submitting an abstract,
(b) giving access to peers for the review of the abstract,
(c) allowing the author to enter the body of the presentation, and
(d) presenting the presentation to peers, and
providing a venue management tool for
managing the presentation given by a plurality of authors each with a different presentation to peers in a venue, and
reporting to each author data associated with the presentations given at the venue.

42. The method of claim 41, wherein the step of providing a venue management tool includes the step of (c) providing an academic currency report.

43. The method of claim 41, wherein the step of submitting the abstract by the author is preceded by the step of logging into a personalized portal with submission links.

44. The method of claim 41, wherein the step of submitting the abstract by the author is preceded by the step of logging into a submission portal.

45. The method of claim 41, wherein the venue management tool further comprises a step of awarding at least one presentation with an award.

46. The method of claim 42, wherein the personalized portal is an online scientific interface operating within the memory of a web server connected to a user browser through an Internet connection, the interface comprising a plurality of customized tabs, wherein the plurality of tabs includes at least a personalized interface tab, and a personalized search tab, wherein the personalized interface tab includes at least a user profile, an access window to a reference database, and a list of abstracts submitted to an operator of the online scientific interface for approval.
